(19) United States
(12) Patent Application Publication
(10) Pub. No.: US 2025/0207976 A1
(43) Pub. Date: Jun. 26, 2025

(54) METHOD AND APPARATUS FOR DETERMINING AT LEAST ONE ADJUSTED SAMPLE COATING TO MATCH THE APPEARANCE OF A REFERENCE COATING

(71) Applicant: BASF COATINGS GMBH, Muenster (DE)

(72) Inventors: Florian STEUFMEHL, Muenster (DE); Guido BISCHOFF, Muenster (DE); Ralf FRANK, Muenster (DE)

(21) Appl. No.: 18/847,504

(22) PCT Filed: Apr. 21, 2023
(86) PCT No.: PCT/EP23/60444

§ 371 Date: Sep. 16, 2024

(30) Foreign Application Priority Data
Apr. 25, 2022 (EP) 22169737.8

(51) Int. Cl. G01J 3/46

(52) U.S. Cl. CPC G01J 3/463

(57) ABSTRACT

Disclosed herein are a method for determining at least one adjusted sample coating to match the appearance of a reference coating, and respective systems, apparatuses, or computer elements. Further disclosed herein are methods and respective systems, apparatuses, or computer elements for determining at least one adjusted sample coating to match the appearance of a reference coating by considering visual deviations in appearance between a sample coating and an associated reference coating which are subjectively perceived by a human observer.

### FIELD

Aspects described herein generally relate to a method for determining at least one adjusted sample coating to match the appearance of a reference coating, and respective systems, apparatuses, or computer elements. More specifically, aspects described herein relate to methods and respective systems, apparatuses, or computer elements for determining at least one adjusted sample coating to match the appearance of a reference coating by considering visual deviations in appearance between a sample coating and an associated reference coating which are subjectively perceived by a human observer. This allows to determine if an adjusted sample coating which is considered a better appearance match based on the appearance data also reduces or eliminates the subjectively perceived visual differences between the sample and the reference coating or not. In case the adjusted sample coating cannot reduce or eliminate the subjectively perceived visual differences, further adjusted sample coatings and/or further matching sample coatings obtained from a database search can be provided. Considering the subjectively perceived visual differences between a sample and a reference coating during determination of an adjusted sample coating allows to only provide adjusted sample coatings which reduce the subjectively perceived difference in appearance between the sample coating and the reference coating, thus avoiding proposal of adjusted sample coatings not being a better match with respect to appearance than the sample coating for the human observer. This approach reduces the number of steps and the amount of time necessary to obtain a sufficient degree of matching with respect to the appearance.

### BACKGROUND

Surface coatings such as monocoat, clearcoat/colorcoat, and tricoat are favored for the protection and decoration of substrates such as vehicle bodies. The surface coatings can contain one or more pigments or effect pigments to impart the desired color or appearance, such as solid, metallic, pearlescent effect, gloss, or distinctness of image, to the vehicle bodies. Metallic flakes, such as aluminum flakes are commonly used to produce coatings having flake appearances such as texture, sparkle, glint and glitter as well as the enhancement of depth perception in the coatings imparted by the flakes.

Repair of such coatings that have been damaged, e.g., in a collision or stone chipping or scratches, has been difficult in that a vehicle repair body shop or a refinisher may have to go to great lengths to repeatedly try out and to locate a best aftermarket refinish coating composition that matches the color and appearance of the vehicle's original coating, also known as original equipment manufacturing (OEM) coating. While each coating composition used in a vehicle's original coating is manufactured to a given color standard, so that, in theory, all vehicles painted with a given coating composition should appear the same color and appearance, due to a host of different variables, such as changing atmospheric conditions and use of different application techniques, the appearance of a given coating composition may actually vary from plant to plant and over different times of any year. Consequently, vehicles manufactured at one plant may appear a different color than vehicles painted with the same coating composition at another plant. A number of refinish matching coating compositions must therefore be developed for each OEM coating composition.

Various color matching techniques have been developed in the past to help selecting the correct matching coating composition to repair the coating of a vehicle, but all suffer from certain significant limitations. For instance, visual tools such as refinish color chips have been used to find a suitable match for the vehicle that needs refinishing. However, visual color matching is time-consuming, cumbersome and subject to many errors as a result of poor lighting conditions, operator variances, or variation to the original standard by the paint manufacturer. Another system involves the use of vehicle data, such as its make, model year and manufacturer's paint code. The paint code is used to identify all the different aftermarket refinish matching coating compositions and corresponding coating formulas created for that paint code. Additional information further defining the matching coatings resulted from the matching coating compositions is associated to each formula which helps the refinisher define which is the best match for the vehicle of that make and model year in question. Such information is gathered from a number of sources and resides in either electronic or printed formats. Accessing such a bank of information is very time-consuming and does not always lead to the correct coating match.

A further system commonly employed involves the use of a computer controlled colorimeter or spectrophotometer which measures the color values of an undamaged area of the coating on the vehicle and compares these color values stored in a database that contains color data for various refinish matching coatings and corresponding matching formulas. From that comparison, the computer locates one or more preliminary matching formulas for the vehicle's original coating color and appearance within an acceptable tolerance. After selecting one of the preliminary matching formulas, the coating material prepared from said formula is sprayed onto a small panel to prepare a small sample and the visual result is compared to the undamaged area of the coating vehicle. In case an acceptable color match is not achieved, an adjusted formula can be calculated from the color data of the reference (i.e. the color values of undamaged areas of the coating on the vehicle) and the sample (i.e. the small panel) by minimizing the difference between the reference color and the predicted color outcome of the adjusted sample formula, for example as described in EP 2 149 038 B1. The improvement of the adjusted sample formulation needs to be verified manually by preparing another sample as previously described and comparing the result to the result of previously selected suggested preliminary matching formulas or the expected result of further suggested preliminary matching formulas. Since many variables and constraints need to be considered during calculation of the adjusted sample formula and visual color match assessment is very subjective, the adjusted sample formula calculated by the previously described color adjustment algorithm may not result in an improvement with respect to the subjectively perceived visual difference.

In an automotive refinish body shop, the user often lacks the coloristic expertise to identify the appropriate steps if retrieved preliminary matching formulas or adjusted sample formulas do not result in the required degree of matching, Moreover, the users most often do not have the time to perform many iterations of the matching operation. It would therefore be desirable to perform matching operations with respect to appearance, such as color, which are not associated with the aforementioned drawbacks. More specifically, there is still a need to improve the efficiency and robustness of matching operations with respect to appearance, such as color.

### Definitions

As used herein, “determining” also includes, initiating or causing to determine “, “generating”, “querying”, “accessing”, “correlating”, “matching”, “selecting” also includes, initiating or causing to generate, access, query, correlating, select and/or match” and “providing” also includes “initiating or causing to determine, generate, access, query, correlating, select and/or match, send and/or receive”. “Initiating or causing to perform an action” includes any processing signal that triggers a computing node to perform the respective action.

“Appearance” refers to the visual impression of the coated object to the eye of an observer and includes the perception in which the spectral and geometric aspects of a surface is integrated with its illuminating and viewing environment. In general, appearance includes color, visual texture such as coarseness caused by effect pigments, sparkle, or other visual effects of a surface, especially when viewed from varying viewing angles and/or with varying illumination angles. The term “clearcoat appearance” refers to the visual impression of an object coated with at least one clearcoat layer to the eye of the observer. The clearcoat appearance can, for example, be characterized by the presence or absence of orange peel (reflected by shortwave and longwave values) as well as the brilliance and gloss (reflected by DOI or Distinctness of Image values).

“Reference coating” may refer to a coating having defined properties, such as defined colorimetric properties. The reference coating can be prepared by applying at least one defined coating material to a surface and curing said applied coating material. In contrast, the term “sample coating” may refer to a coating that is evaluated in comparison with the reference coating with respect to at least part of the defined properties, such as colorimetric properties.

The sample coating can be prepared using a mixing formula or by a mixing ingredients according to a given recipe. Such mixing formula or recipe may be identified based on the reference coating. For instance, appearance data of the reference coating may be used to perform commonly known color matching processes to identify mixing formulae or recipes supposed to result in a sample coating matching the appearance of a reference coating. The term “sample coating formulation” refers to the coating material used to prepare the sample coating while the term “reference coating formulation” refers to the coating material used to prepare the reference coating. The term “adjusted sample coating” refers to a sample coating and associated sample coating formulation where at least one component present within the sample coating formulation has been modified, for example by modifying the amount and/or type of said component, with respect to the sample formulation (i.e. the unmodified sample formulation). Modification of the sample coating can be performed, for example, by calculating an adjusted sample coating using optimization methods commonly known in the state of the art or by manually adjusting the type and/or amount of the at least one component. The terms “formulation”, “color formulation” and “paint formulation” are used synonymously herein. “Digital representation” may refer to a representation of the sample coating, the reference coating, the adjusted sample coating and the visual assessment of the sample coating in a computer readable form. In particular, the digital representation of the reference coating contains appearance data of the reference coating. The digital representation of the reference coating may further include the color name, the color number, the color code, a bar code, a QR code, a unique database ID, a mixing formula (i.e. instructions to prepare the coating material associated with the reference coating), a price, the layer structure of the reference coating, the manufacturer of the coating materials used to prepare the reference coating, the manufacturer of the substrate comprising the reference coating, the model comprising the reference coating, the production year of the substrate comprising the reference coating, the car part comprising the reference coating or a combination thereof. The digital representation of the sample coating contains appearance data of the sample coating as well as the sample coating formulation(s). The digital representation of the sample coating may further comprise the color name, the color number, the color code, a bar code, a QR code, a unique database ID, a mixing formula (i.e. instructions to prepare the coating material associated with the sample coating), color rankings, matching score(s), a price, application parameters associated with the preparation of the sample coating from sample coating formulation(s), the layer structure of the sample coating, the type of clearcoat present within the sample coating, the manufacturer(s) of the coating formulations(s) used to prepare the sample coating or a combination thereof. The digital representation of the adjusted sample coating comprises at least appearance data of the adjusted sample coating and may further contain, for example, the formulation(s) of the adjusted sample coating. The digital representation of the visual assessment of the sample coating contains at least one human-perceived attribute assigned to the sample coating and may be obtained by mapping the rating of the sample coating with respect to its deviation from the reference coating to respective human-perceived attributes. The digital representation of the visual assessment of the sample coating may further contain data being indicative of the sample coating and the reference coating, such as the color name, color number, bar code, QR code, unique database ID of the sample coating and the reference coating, respectively.

“Human-perceived attribute” assigned to the sample coating refers to an attribute of a coating sample coating in relation to the reference coating, such as a difference in the lightness, darkness, texture, color, gloss and/or clearcoat appearance, which is perceived by a human observer, such as a refinisher upon visually comparing the prepared sample coating to the reference coating. The human-perceived attribute assigned to the sample coating is improved by the adjusted sample coating if the difference between the reference coating and the adjusted sample coating associated with said attribute is less than the difference between the sample coating and the reference coating.

“Communication interface” may refer to a software and/or hardware interface for establishing communication such as transfer or exchange or signals or data. Software interfaces may be e.g. function calls, APIs. Communication interfaces may comprise transceivers and/or receivers. The communication may either be wired, or it may be wireless. Communication interface may be based on or it supports one or more communication protocols. The communication protocol may a wireless protocol, for example: short distance communication protocol such as Bluetooth®, or WiFi, or long distance communication protocol such as cellular or mobile network, for example, second-generation cellular network (“2G”), 3G, 4G, Long-Term Evolution (“LTE”), or 5G. Alternatively, or in addition, the communication interface may even be based on a proprietary short distance or long distance protocol. The communication interface may support any one or more standards and/or proprietary protocols.

“Display device” refers to an output device for presentation of information in visual or tactile form (the latter may be used in tactile electronic displays for blind people). “Screen of the display device” refers to physical screens of display devices and projection regions of projection display devices alike.

“Hardware processor” refers to an arbitrary logic circuitry configured to perform basic operations of a computer or system, and/or, generally, to a device which is configured for performing calculations or logic operations. In particular, the processing means, or computer processor may be configured for processing basic instructions that drive the computer or system. As an example, the processing means or computer processor may comprise at least one arithmetic logic unit (“ALU”), at least one floating-point unit (“FPU)”, such as a math coprocessor or a numeric coprocessor, a plurality of registers, specifically registers configured for supplying operands to the ALU and storing results of operations, and a memory, such as an L1 and L2 cache memory. In particular, the processing means, or computer processor may be a multicore processor. Specifically, the processing means, or computer processor may be or may comprise a Central Processing Unit (“CPU”). The processing means or computer processor may be a (“GPU”) graphics processing unit, (“TPU”) tensor processing unit, (“CISC”) Complex Instruction Set Computing microprocessor, Reduced Instruction Set Computing (“RISC”) microprocessor, Very Long Instruction Word (“VLIW”) microprocessor, or a processor implementing other instruction sets or processors implementing a combination of instruction sets. The processing means may also be one or more special-purpose processing devices such as an Application-Specific Integrated Circuit (“ASIC”), a Field Programmable Gate Array (“FPGA”), a Complex Programmable Logic Device (“CPLD”), a Digital Signal Processor (“DSP”), a network processor, or the like. The methods, systems and devices described herein may be implemented as software in a DSP, in a micro-controller, or in any other side-processor or as hardware circuit within an ASIC, CPLD, or FPGA. It is to be understood that the term processing means or processor may also refer to one or more processing devices, such as a distributed system of processing devices located across multiple computer systems (e.g., cloud computing), and is not limited to a single device unless otherwise specified.

The term “hardware logic circuitry” corresponds to one or more hardware processors (e.g., CPUs, GPUs, etc.) that execute machine-readable instructions stored in a memory, and/or one or more other hardware logic components (e.g., FPGAs) that perform operations using a task-specific collection of fixed and/or programmable logic gates. Section C provides additional information regarding one implementation of the hardware logic circuitry. Each of the terms “component” and “engine” refers to a part of the hardware logic circuitry that performs a particular function.

“Data storage medium” may refer to physical and other computer-readable media for carrying or storing computer-executable instructions and/or data structures. Such computer-readable media can be any available media that can be accessed by a general-purpose or special-purpose computer system. Computer-readable media may include physical storage media that store computer-executable instructions and/or data structures. Physical storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality of the invention.

“Computer readable program instructions” described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

“Database” may refer to a collection of related information that can be searched and retrieved. The database can be a searchable electronic numerical, alphanumerical, or textual document; a searchable PDF document; a Microsoft Excel® spreadsheet; or a database commonly known in the state of the art. The database can be a set of electronic documents, photographs, images, diagrams, data, or drawings, residing in a computer readable storage media that can be searched and retrieved. A database can be a single database or a set of related databases or a group of unrelated databases. “Related database” means that there is at least one common information element in the related databases that can be used to relate such databases.

### SUMMARY

To address the above-mentioned problems in a perspective the following is proposed:

a computer-implemented method for determining at least one adjusted sample coating to match the appearance of a reference coating, in particular during vehicle repair, said method comprising:
(i) providing to a computer processor via a communication interface
   a digital representation of the sample coating containing appearance data of the sample coating and the sample coating formulation(s),
   a digital representation of the reference coating containing appearance data of the reference coating,
   a digital representation of an adjusted sample coating containing appearance data of the adjusted sample coating and optionally the adjusted sample coating formulation(s), and
   a digital representation of a visual assessment of the sample coating containing at least one human-perceived attribute assigned to the sample coating by a human observer,
(ii) determining—with the computer processor-if the adjusted sample coating improves at least one human-perceived attribute assigned to the sample coating based on the digital representations provided in step (i); and

(iii) optionally providing the result of the determination of step (ii) via a communication interface.

Further disclosed is:

A computer-implemented method for determining at least one adjusted sample coating to match the appearance of a reference coating, in particular during vehicle repair, said method comprising:
(i) providing to a computer processor via a communication interface.
   a digital representation of the sample coating containing appearance data of the sample coating and the sample coating formulation(s),
   a digital representation of the reference coating containing appearance data of the reference coating,
   a digital representation of the adjusted sample coating containing appearance data of the adjusted sample coating and optionally adjusted sample coating formulation(s), and
   a digital representation of a visual assessment of the sample coating containing at least one human-perceived attribute assigned to the sample coating in comparison to the reference coating by a human observer, wherein the digital representation is provided by
      providing a user interface on the screen of a display device including display images displaying at least one perceived deviation of the sample coating from the reference coating with respect to lightness and/or darkness and/or color and/or texture and/or gloss and/or clearcoat appearance,
      detecting a user input being indicative of selecting at least one perceived deviation of the sample coating from the reference coating, wherein the user input is associated with the visual evaluation of the sample coating with respect to the reference coating, and
      generating the digital representation of the visual assessment of the sample coating by assigning at least one human-perceived attribute to the sample coating based on the detected user input and providing the generated digital representation of the visual assessment of the sample coating,
(ii) determining—with the computer processor-if the adjusted sample coating improves at least one human-perceived attribute assigned to the sample coating based on the digital representations provided in step (i);
(iii) optionally providing the result of the determination of step (iii) via a communication interface.

### Further Disclosed is:

A computer-implemented method for determining at least one adjusted sample coating to match the appearance of a reference coating, in particular during vehicle repair, said method comprising:
(i) providing to a computer processor via a communication interface
   a digital representation of the sample coating containing appearance data of the sample coating and the sample coating formulation(s),
   a digital representation of the reference coating containing appearance data of the reference coating,
   a digital representation of the adjusted sample coating containing appearance data of the adjusted sample coating and optionally adjusted sample coating formulation(s), and
   a digital representation of a visual assessment of the sample coating containing at least one human-perceived attribute assigned to the sample coating in comparison to the reference coating by a human observer, wherein the digital representation is provided by
      providing a user interface on the screen of a display device including display images displaying at least one perceived deviation of the sample coating from the reference coating with respect to lightness and/or darkness and/or color and/or texture and/or gloss and/or clearcoat appearance,
      detecting a user input being indicative of selecting at least one perceived deviation of the sample coating from the reference coating, wherein the user input is associated with the visual evaluation of the sample coating with respect to the reference coating, and
      generating the digital representation of the visual assessment of the sample coating by assigning at least one human-perceived attribute to the sample coating based on the detected user input and providing the generated digital representation of the visual assessment of the sample coating,
(ii) determining—with the computer processor-if the adjusted sample coating improves at least one human-perceived attribute assigned to the sample coating based on the digital representations provided in step (i);
(iii) optionally providing the result of the determination of step (iii) via a communication interface;
(iv) providing the digital representation of the adjusted sample coating via the communication interface in accordance with the determination that the adjusted sample coating improves at least one human-perceived attribute assigned to the sample coating, or determining at least one further sample coating based on the provided digital representation of the reference coating and providing the determined further sample coating(s) via the communication interface in accordance with the determination that the adjusted sample coating does not improve at least one human-perceived attribute assigned to the sample coating.

It is an essential advantage of the method according to the present invention that the visual difference between the sample coating, such as a sample coating associated with a preliminary matching formula resulting from a color matching operation, and the reference coating subjectively perceived by a human observer is considered to determine whether an adjusted sample coating will result in an appearance which is subjectively perceived as a better matching appearance by said observer. Visually perceived deviations between the sample coating and the reference coating are displayed using display images within a user interface. This allows the user to rate the deviations easily and intuitively in the virtual world represented by the user interface by selecting the display image of the modified reference coating that best describes the differences between the prepared sample coating and the reference coating visually perceived in the physical world. Hence, the difference between the sample coating and the reference coating in the physical world may be translated into the virtual world, e.g. into human-perceived attributes associated with the sample coating, using a standardized process. The human-perceived attributes may represent data that defines the visually perceived differences between the sample coating and the reference coating. The sample coating may be prepared by a user performing the inventive method by initiating a color matching operation based on the appearance data of the reference coating and preparing the sample coating using one of the sample coating identified best matching sample coating formulations. The color matching operating may be performed by a further computing processor or a computing resource of a cloud computing environment being different from the computing processor implementing the methods disclosed herein. Use of said subjectively perceived visual difference allows to determine whether the adjusted sample coating calculated using the appearance data of the sample coating and the reference coating will reduce or eliminate said differences or not. This allows to only provide adjusted sample coatings which reduce the subjectively perceived differences in appearance between the sample coating and the reference coating, thus avoiding proposal of adjusted sample coatings not being a better match with respect to appearance to the respective human observer, such as a refinisher in a body shop. This approach reduces the number of steps the user has to perform to obtain a sufficient appearance match because unsuitable adjusted sample coatings are not presented to the user as suitable solutions. The digital representation of the adjusted sample coating formulation may be determined by a further computer processor or a computing resource of a cloud computing environment performing a color matching operating based on the appearance data of the reference coating and the sample coating and the determined data may be provided to the computer processor performing the inventive method.

Further disclosed is:

an apparatus for determining at least one adjusted sample coating to match the appearance of a reference coating, the apparatus comprising: one or more computing nodes; and one or more computer-readable media having thereon computer-executable instructions that are structured such that, when executed by the one or more computing nodes, cause the apparatus to perform the inventive method.

### Further Disclosed is:

a computer program element with instructions, which, when executed by a computing device, such as a computing device of a computing environment, is configured to carry out the steps of the inventive method or as provided by the inventive apparatus.

### Further Disclosed is:

a client device for generating a request to determine at least one adjusted sample coating to match the appearance of a reference coating, wherein the client device is configured to provide a digital representation of a sample coating, a digital representation of a reference coating and a digital representation of a visual assessment of the sample coating to a server device.

Any disclosure and embodiments described herein relate to methods, systems, apparatuses and computer elements disclosed herein and vice versa. Benefits provided by any of the embodiments and examples provided herein equally apply to all other embodiments and examples and vice versa.

### EMBODIMENTS

### Embodiments of the Inventive Method

The inventive computer-implemented method allows to determine whether at least one adjusted sample coating matches the appearance, in particular the color and/or the clearcoat appearance, of a reference coating. For this purpose, it is determined whether an adjusted sample coating improves at least one human-perceived attribute assigned to the sample coating based on the provided digital representations. Data associated with the adjusted sample coating can, for example, be obtained by identifying a preliminary matching sample coating formulation based on provided appearance data of the reference coating as commonly done during repair operations and preparing a sample coating by applying an identified matching sample coating formulation and optionally further coating formulations, such as clearcoat formulations, onto a substrate and curing the applied coating formulations. Afterwards, the appearance data of the prepared sample coating is determined and used-along with the identified matching sample coating formulation—to determine data associated with the adjusted sample coating by adjusting at least one ingredient (type and/or amount of ingredient(s)) present within the sample coating formulation as described later on. The matching sample coating formulation may be determined by performing color matching operations commonly known in the state of the art based on appearance data of the reference coating. The color matching operations may be performed by a further computer processor or a computing resource of a cloud computing environment being separate from the computer processor performing the methods disclosed herein. The color matching operation may be initiated by a user performing a repair process on a damaged coating. Data associated with the adjusted sample coating formulation may likewise be determined by a further computer processor or a further computing resource. The further computer processor or computing resource may be the same further computing processor or computing resource determining the sample coating formulation or yet a further computing processor or computing resource. Determination of data associated with the adjusted sample coating formulation may be initiated by the user performing the inventive method. For example, the user may select on a graphical user interface that the sample coating does not sufficiently match the appearance of the reference coating and that user input may trigger determination of the data associated with the adjusted sample coating.

The computer processor performing steps (i) to (iii) and any further steps described later on is may be present within a computing device, for example a mobile or stationary computing device, such as a personal computer, a laptop, a smartphones, a tablet, etc. The computer processor may retrieve or receive the digital representations in step (i). The computer processor may retrieve or receive said digital representations via endpoints, such as APIs. The endpoints may be associated with computing resources providing the respective digital representation. Hence, each digital representation provided in step (i) may be provided from a computing resource via an endpoint, such as an API. The computing processor implementing the methods disclosed therein may be configured to make calls to such endpoints and to retrieve or receive respective digital representations from such endpoints.

### Step (i):

In step (i) of the inventive method, a number of digital representations, namely the digital representation of the sample coating, the reference coating, the adjusted sample coating and the visual assessment of the sample coating, are provided via a communication interface to the computer processor. The data may be provided to the computer processor from another computing resource determining such data and/or from a data storage medium storing said data. Data provisioning may be initiated by a user performing the methods disclosed herein. For instance, a user may initiate provisioning of said data upon indicating that the appearance of the prepared sample coating does not match the appearance of the reference coating. This may trigger provisioning of the digital representation of the reference coating and the digital representation of the sample coating. This may trigger determination of the digital representation of the adjusted sample coating, for example by a further computing resource performing adjustment operations on the sample coating formulation, and provisioning of said determined digital representation. This may trigger determination of the digital representation of the visual assessment, for example by displaying a user interface allowing the user to enter the perceived difference between the reference coating and the sample coating using display images as described later on, and provisioning of the determined digital representation.

The digital representation of the sample coating provided via the communication interface to the computer processor in step (i) includes at least appearance data of the sample coating and the sample coating formulation(s). In an aspect, the digital representation of the sample coating further comprises the color name, the color code, a bar code, a QR code, a mixing formula, a color ranking, a matching score, application parameters associated with the preparation of the sample coating from a sample coating formulation, the layer structure of the sample coating, the type of clearcoat present within the sample coating, the manufacturer of the coating formulation(s) used to prepare the sample coating, a price, or a combination thereof.

Provision of the aforementioned digital representations can be performed by numerous ways, some of which are illustrated in a non-limiting manner below.

Digital representation of sample coating and/or reference coating:

In an aspect, providing the digital representation of the sample coating and/or the reference coating includes
measuring the appearance of the sample effect coating and/or the reference coating at one or more measurement geometries with a measuring device and optionally determining appearance data from the measured data with the measuring device, and
retrieving—with the computer processor via the communication interface—the determined appearance data optionally in combination with further meta data and/or user input or
retrieving—with the computer processor via the communication interface—the measured data optionally in combination with further meta data and/or user input and optionally determining appearance data from the measured data with the computer processor.

The appearance of the reference and/or sample coating can be measured with suitable measuring devices, for example RGB cameras, single-angle spectrophotometers, multi-angle spectrophotometers, gloss meters and wave-scan measurement devices. Commercially available RGB cameras include smartphone cameras, digital cameras, mirror cameras, etc. Commercially available multi-angle spectrometers are, for example, Byk-Mac® | or a spectrometer of the XRite MA®-T-family. Commercially available single-angle spectrophotometers include, for example, the Byk ColorView, the Datacolor Spectraflash SF450 and the Konica Minolta CM 3600-d.

The measuring device may be connected to a computer processor via a communication interface. In one example, the processor is programmed to process the measured data, such as reflectance data and texture images, by calculating the appearance data for each measurement geometry from the measured reflectance and/or by calculating the texture characteristics for a defined measurement geometry from the acquired texture image. Said processor may be present separate from the computing device, for example within the measurement device or may be included in a computing resource of cloud computing environment. In this case, the processor implementing the methods disclosed herein may retrieve the determined appearance data, optionally in combination with further meta data and/or user input via the communication interface. In another example, the processor implementing the methods disclosed herein retrieves the measured data and optionally further data mentioned above without performing any further calculations, for example if an RGB camera was used to measure the appearance. In this case, the measured data corresponds to the appearance data.

The appearance data may be stored on a data storage medium, such as an internal memory or a database prior to providing the appearance data via the communication interface to the processor implementing the methods disclosed herein or after providing said data to the processor implementing the methods disclosed herein. This may include interrelating the appearance data with further data and/or meta data and/or user input prior to storing the appearance data such that the stored appearance data can be retrieved using the further data and/or meta data and/or user input if needed. Storing the appearance data may be preferred if said data is needed several times since the data does not have to be acquired each time the inventive method is performed.

Further data and/or meta data and/or user input may include a color number/color code/bar code/unique database ID associated with the respective coating, the layer structure of the respective coating, the wet or dry film thickness of the respective coating, instructions to prepare the respective coating material(s) associated with the respective coating, the price or a combination thereof.

In one example, the appearance data is obtained from data acquired at a single measurement geometry. This may be preferred if the reference coating is a solid color or straight shade coating or if a single-angle measurement device (i.e. a measurement device acquiring data of the appearance of the reference coating at only a single measurement geometry) is used. The term “solid color or straight shade coating” refers to coatings where the colored coating layers primarily contain colored pigments, and the coating does not exhibit a visible flop or two tone metallic effect, i.e. the visual appearance does not change with viewing and/or illumination angle.

In another example, the appearance data is obtained from data acquired at a plurality of measurement geometries. Use of appearance data obtained from data acquired at a plurality of measurement geometries may be preferred if the reference coating is an effect coating, i.e. a coating comprising at least one colored coating layer containing effect pigment(s) and optionally other colored pigments or spheres which result in a visual flop or two-tone metallic effect, because the appearance of an effect coating changes with viewing and/or illumination angles.

In an alternative aspect, providing the digital representation of the reference coating includes providing reference coating identification data, obtaining the digital representation of the reference coating based on provided reference coating identification data and providing the obtained digital representation. The digital representation of the reference coating can be obtained by retrieving the digital representation of the reference coating based on provided reference coating identification data and providing the retrieved digital representation via the communication interface to the computer processor implementing the methods disclosed herein. In one example, obtaining the digital representation of the reference coating based on the provided reference coating identification data includes accessing a database containing digital representations of reference coatings interrelated with reference coating identification data, such as appearance data of the reference coating, the color name, color code, bar code, etc. of the reference coating or further data being indicative of the reference coating, and retrieving the digital representation of the reference coating based on said provided data. Data being indicative of the reference coating may include the color name, color number, color code, bar code, ID, VIN in combination with car part information (e.g. bumper, trunk, etc.), etc.

associated with the reference coating. The data being indicative of the reference coating may be inputted by the user via a GUI displayed on the display, retrieved from a database based on scanned code, such as a QR code, or may be associated with a pre-defined user action. Predefined user actions may include selecting a desired action on the GUI displayed on the display, such as, for example, displaying a list of stored measurements including associated images or displaying a list of available reference coatings according to searching criteria, user profile, etc.

The database is preferably connected to the processor implementing the methods disclosed herein via a communication interface and the digital representation of the reference coating may be provided to the processor implementing the methods disclosed herein by selecting a digital representation stored on a data storage medium, for example via a GUI displayed on the screen of the display or by entering data being indicative of the reference coating, such as the color name, the color code, etc. and retrieving the digital representation of the reference coating based on the entered data.

In an aspect, the appearance data contained in the digital representation of the sample coating, the reference coating and the adjusted sample coating includes reflectance data, color space data, in particular CIEL*a*b* values or CIEL*C*h* values, gloss data, shortwave values, longwave values, DOI values, texture images, texture characteristics or a combination thereof. The term “texture characteristics” refers to the coarseness characteristics and/or sparkle characteristics of an effect coating. The coarseness characteristics and the sparkle characteristics of effect coatings can, for example, be determined from texture images acquired by multi-angle spectrophotometers according to methods well known in the state of the art. Texture images can be black-and-white images or can be color images. One example of color space data is defined by L*a*b*, where L* represents luminous intensity, a* represents a red/green appearance, b* represents a yellow/blue appearance. Another example of color space data is defined by L*, C*, h, where L* represents lightness, C* represents chroma, and h represents hue. Yet another example of color space data is defined by RGB, where R represents the red channel, G represents the green channel, and B represents the blue channel.

Digital representation of the adjusted sample coating:

In an aspect, providing the digital representation of the adjusted sample coating includes
calculating—with a further computer processor—an adjusted sample coating formulation based on the digital representation of the reference coating and the sample coating,
calculating appearance data based on the calculated adjusted sample coating formulation, and
providing the calculated appearance data and optionally the adjusted sample coating formulation as digital representation of the adjusted sample coating via the communication interface.

The further computer processor may be present separate from the computer processor implementing the methods disclosed therein. For instance, the further computer processor may be part of a computing resource of a distributed computing environment. This allows to balance the required computing power, reducing latency and the time until the digital representation of the adjusted sample coating can be provided, for example via the communication interface, to the processor implementing the methods disclosed therein.

In one example, the adjusted sample coating formulation is calculated based on the digital representation of the reference coating and the sample coating by
providing a digital representation of individual color components containing optical data of individual color components and a physical model configured to predict the color of the sample coating by using as input parameters the sample coating formulation and optical data of individual color components,
determining the color difference between the provided appearance data of the sample coating and the provided appearance data of reference coating,
determining the model bias of the provided physical model by predicting color data of the sample coating based on the digital representation of the sample coating, the digital representation of individual color components and the provided physical model and determining the color difference between the provided appearance data of the sample coating and the predicted appearance data of the sample coating, and
calculating an adjusted sample coating formulation based on the determined color difference, the provided optical data of individual color components, the determined model bias and the provided physical model.

The term “individual color component” refers to separate components present within a coating formulation, such as the sample coating formulation and the reference coating formulation. Examples of individual color components include pigments, such as color and effect pigments, binders, solvents and additives, such as for example matting pastes. With preference, the term “individual color component” refers to pigment pastes or pigments, such as color and effect pigments. The term “optical data of individual color components” refers to optical properties and/or the specific optical constants of the individual color components. The optical constants of the individual color components are parameters in a physical model and can be determined by preparing reference coatings using reference batches of pigment pastes and determining the optical properties of said reference coatings, for example by measuring the reflectance spectra of the prepared reference coating with a spectrophotometer. From the reflectance spectra and the corresponding formulation data, the specific optical properties, such as the K/S constants, can be determined and assigned as optical data to the respective individual color components. The terms “optical data of individual color components”, “optical data of the individual color components” or “optical data of the colorants” are used synonymously. The term “physical model” refers to a deterministic color prediction model based on physical laws. With particular preference, the physical model used according to the invention is based on physical laws describing the light absorption and light scattering properties of pigmented systems.

The term “model bias” (also called physical model bias hereinafter) refers to the systematical error of the physical model during prediction of color data based on the coating formulation and optical data of individual color components. The systematical error comprises limitations of the physical model as well as a bias present in the optical data of the individual color components present in the sample coating formulation. The bias present in the optical data of individual color components arises, for example from the difference in colorant strength characteristics of pigment pastes used to prepare the reference coatings and colorant strength characteristics of pigment pastes used to prepare the sample coatings because the colorant strength characteristics of pigment pastes deviates from batch to batch due to deviations in the raw materials (such as pigments) used to prepare the pigment pastes.

The optical data of individual color components preferably includes optical constants of the individual color components, in particular wavelength dependent scattering and absorption properties of the individual color components. The optical constants may further include the orientation of individual color components, such as effect pigments, within the coating.

The color difference can be determined using a color tolerance equation or using the shape similarity of spectral curves. Suitable color tolerance equations include the Delta E (CIE 1994) color tolerance equation, the Delta E (CIE 2000) color tolerance equation, the Delta E (DIN 99) color tolerance equation, the Delta E (CIE 1976) color tolerance equation, the Delta E (CMC) color tolerance equation, the Delta E (Audi95) color tolerance equation, the Delta E (Audi2000) color tolerance equation or other color tolerance equations. Use of the shape similarity of the spectral curves is preferable because it avoids changing the characteristic or “fingerprint” of the individual color components which would render the color adjustment process more complicated. The determined color difference may be stored on a data storage medium, such an internal data storage medium or a database. The determined color difference may be interrelated with further data, such as data contained in the provided digital representation of the sample coating formulation, to allow retrieval of the data in any one of the following method steps.

To determine the model bias, the physical model is used to predict the appearance data of the sample coating based on the provided digital representation of the sample coating and the provided digital representation of the individual color components. Afterwards, the color difference between the appearance data of the sample coating contained in the provided digital representation of the sample coating and the predicted appearance data of the sample coating is determined. The color difference may be determined as described previously. The appearance of the sample coating is preferably predicted using the sample coating formulation and the optical data, in particular the optical constants, of the individual color components present within the sample coating formulation as input parameters for the provided physical model.

In one example, the adjusted sample coating formulation is calculated by
providing a numerical method configured to adjust the concentration of at least one individual color component present in the sample coating formulation by minimizing a given cost function starting from the concentrations of the individual color components contained in the provided digital representation of the sample coating, and
adjusting the concentration of at least one individual color component present in the sample coating formulation using the provided numerical method, the provided optical data, the model bias and the provided physical model by comparing the recursively predicted color data of the recursively adjusted formulation of the sample coating with the provided appearance data of the reference coating until the color difference falls below a given threshold value or until the number of iterations reaches a predefined limit.

A suitable numerical method includes the Levenberg-Marquardt algorithm (called LMA or LM), also known as the damped least-squares (DLS) method. The numerical method may be stored on a data storage medium, such as the internal memory of a computing device comprising the computer processor or in a database connected via the communication interface to the computer processor and may be retrieved upon calculating the modified sample coating formulation.

In one example, the cost function is a difference between the predicted appearance data of the sample coating and the appearance data of the reference coating. Said difference can be calculated as described above. In case the cost function is a color difference, the given threshold value is preferably a given color difference.

The formulation of the sample coating may be adjusted using the optical data and the recursively adjusted sample coating formulation as input parameters for the provided physical model. The provided physical model may then predict the appearance data, such as reflectance data, of the adjusted sample coating formulation based on the input parameters. This prediction may be performed for each adjustment of the sample coating formulation until the cost function falls below a given threshold value or the maximum limit of iterations is reached.

The calculated appearance data and optionally the adjusted sample coating formulation may be provided as digital representation of the adjusted sample coating via the communication interface to the computer processor. The calculated appearance data and optionally the adjusted sample coating formulation may be stored on a data storage medium, for example a database, prior to providing said data as digital representation to the computer processor. The stored data may be interrelated with a unique ID to facilitate retrieval of said data at a later point in time.

### Digital Representation of the Visual Assessment of the Sample Coating:

The digital representation of the visual assessment of the sample coating contains at least one human-perceived attribute assigned to the sample coating by a human observer. In an aspect, the human-perceived attribute is selected from the deviation of the sample coating from the reference coating with respect to lightness and/or darkness and/or color and/or texture and/or gloss and/or clearcoat appearance. In one example, the deviation is a deviation in lightness and/or darkness. In another example, the deviation is a deviation in the color and/or texture. In yet another example, the deviation is a deviation in gloss. In an even further example, the deviation is a deviation in the clearcoat appearance. The deviation in gloss and/or clearcoat appearance may be preferred if the sample coating and the reference coating each comprise at least one clearcoat layer.

In an aspect, providing the digital representation of the visual assessment of the sample coating includes
providing a user interface on the screen of a display device allowing the user to select at least one visually perceivable deviation of the sample coating from the reference coating with respect to lightness and/or darkness and/or color and/or texture and/or gloss and/or clearcoat appearance,
detecting a user input being indicative of selecting at least one visually perceivable deviation of the sample coating from the reference coating,
generating the digital representation of the visual assessment of the sample coating by assigning at least one human-perceived attribute to the sample coating based on the detected user input, and
providing the generated digital representation of the visual assessment via the communication interface.

The term “visually perceivable deviation” refers to possible deviations of the sample coating from the reference coating which can be detected upon visually comparing the sample coating with the reference coating by a human observer.

The user interface may be generated from a user interface presentation and may contain icons, menus, bars, text, labels or a combination thereof. The display device may be connected via a communication interface to the processor implementing the methods disclosed herein. The display of the display device may be constructed according to any emissive or reflective display technology with a suitable resolution and color gamut. Suitable resolutions are, for example, resolutions of 72 dots per inch (dpi) or higher, such as 300 dpi, 600 dpi, 1200 dpi, 2400 dpi, or higher. This guarantees that the generated appearance data can displayed in a high quality. A suitably wide color gamut is that of standard Red Green Blue (sRGB) or greater. In various embodiments, the display may be chosen with a color gamut similar to the gamut perceptible by human sight. In an aspect, the display is constructed according to liquid crystal display (LCD) technology, in particular according to liquid crystal display (LCD) technology further comprising a touch screen panel. The LCD may be backlit by any suitable illumination source. The color gamut of an LCD display, however, may be widened or otherwise improved by selecting a light emitting diode (LED) backlight or backlights. In another aspect, the display is constructed according to emissive polymeric or organic light emitting diode (OLED) technology. In yet another aspect, the display device is constructed according to a reflective display technology, such as electronic paper or ink. Known makers of electronic ink/paper displays include E INK and XEROX. Preferably, the display also has a suitably wide field of view that allows it to display images that do not wash out or change severely as the user views the display from different angles. Because LCD screens operate by polarizing light, some models exhibit a high degree of viewing angle dependence. Various LCD constructions, however, have comparatively wider fields of view and may be preferable for that reason. For example, LCD displays constructed according to thin film transistor (TFT) technology may have a suitably wide field of view. Also, displays constructed according to electronic paper/ink and OLED technologies may have fields of view wider than many LCD displays and may be selected for this reason.

In one example, the user interface further allows the user to select an overall rating for the sample coating. This overall rating may be used by the user to indicate the degree of deviation of the sample coating from the reference coating, for example by selecting a lower overall rating if a large visually perceived deviation is detected while selecting a higher overall rating if a lower visually perceived deviation is detected. Said selected overall rating may be used in step (ii) to determine the degree of improvement which needs to be fulfilled by the adjusted sample coating as described later on.

In one example, the user interface includes display images displaying at least one visually perceivable deviation of the sample coating from the reference coating with respect to lightness and/or darkness and/or color and/or texture and/or gloss and/or clearcoat appearance. The term “color” refers to the color, the chromaticity and the hue of the coating. For example, the modified display images have a darker color and/or a lighter color than the display image of the reference coating. In another example, the modified display images are bluer, yellower, greener or redder than the display image of the reference coating. In yet another example, the modified display images are more sparkling or less sparkling, coarser or finer than the display image of the reference coating. In yet a further example, the modified display images are glossier or less glossy, have more or less orange peel or a lower or higher DOI than the display image of the reference coating. Use of said display images allows to visualize possible deviations with respect to appearance between the sample coating and the reference coating such that observed visual deviations can be assigned to the sample coating by selecting the appropriate display image visualizing the respective deviation without requiring a deep understanding about coloristics and the applicable terms to define deviations for the respective coating type, such as solid color coatings (i.e. a coating not containing effect pigments), effect color coatings (i.e. a coating containing effect pigments), chromatic coatings, achromatic coatings, etc.

In one example, the display images displaying at least one visually perceivable deviation of the sample coating from the reference coating (also referred to as modified display images hereinafter) are generated by:
generating color image(s) by calculating corresponding CIEL*a*b* values for each pixel in each created image based on
   an ordered list of measurement geometries generated from the provided digital representation of the reference coating, and
   a modified digital representation of the reference coating or—if at least one L*value included in the modified digital representation of the reference coating is greater than 90—a scaled modified digital representation of the reference coating;
optionally adding a texture layer pixel-wise to each generated color image using a lightness scaling factor S_{L}, an aspecular-dependent scaling function sf_{aspecular} and optionally a texture contrast scaling factor s_{c}, and
providing the generated modified appearance display data to the display device for display on the screen of said device.

The term “modified appearance display data” refers to modified appearance data (e.g. appearance data that has been modified with respect to the appearance data of the reference coating) that is used to present perceivable deviations of the sample coating from the reference coating. Said modified appearance display data preferably has a standard dynamic range (SDR) format so that no additional tone mapping is required to display said data as it would be necessary for high dynamic range (HDR) data.

The generated color images and thus also the modified appearance display data corresponding to said color images or generated by adding a texture layer to said color images preferably have a defined resolution. Suitable resolutions range from 160×120 pixels to 720×540 pixels, in particular 480×360 pixels. The defined resolution of the color images can be achieved, for example, by creating empty image(s) by defining the number of pixels in the x- and y-direction and using the created empty image(s) to generate the color image(s).

The ordered list of measurement geometries can be generated from the provided digital representation of the reference coating by
selecting at least one pre-defined measurement geometry from the one or more measurement geometries contained in the digital representation and optionally sorting the selected measurement geometries according to at least one pre-defined sorting criterium if more than one measurement geometry is selected, and
optionally calculating the accumulated delta aspecular angle for each selected measurement geometry if more than one measurement geometry is selected.

In one example, the at least one predefined measurement geometry includes at least one gloss measurement geometry and at least one non-gloss measurement geometry or at least one, in particular exactly one, intermediate measurement geometry. The at least one intermediate measurement geometry preferably corresponds to an aspecular angle of 45°. In the first case, at least two pre-defined measurement geometries are selected from the plurality of measurement geometries contained in each provided digital representation, namely at least one gloss and at least one non-gloss measurement geometry. In this case, the selected measurement geometries are sorted according to at least one pre-defined sorting criterium. In the latter preferred case, exactly one pre-defined measurement geometry, namely an intermediate measurement geometry, is selected from the one or more measurement geometries contained in each provided digital representation. In this case, a sorting of the pre-defined measurement geometry is not necessary.

The at least one pre-defined sorting criterium may include a defined order of measurement geometries. This defined order of measurement geometries is preferably selected such that a visual 3D impression, for example a visual impression of a bend metal sheet, is obtained if the appearance display data is displayed within the user interface. Examples of defined orders of measurement geometries include 45°>25°>15°>25°>45°>75 and −15°>15°>25°>45°>75°>110°. Use of these defined orders of measurement geometries may be beneficial for effect coatings because this order results in color images displaying the color travel of the effect coating under directional illumination conditions. The at least one pre-defined measurement geometry and/or the at least one pre-defined sorting criterium may be retrieved by the computer processor from a data storage medium based on the provided digital representation of the reference coating and/or further data. Further data may include data on the user profile or data being indicative of the measurement device and the measurement geometries associated with the measurement device.

The delta aspecular angle for each measurement geometry is the absolute difference angle between the aspecular angle associated with a selected measurement geometry, for example the aspecular angle of 45°, and the aspecular angle associated with the following selected measurement geometry, in this example an aspecular angle of 25°. The accumulated delta aspecular angle can be obtained by adding the delta aspecular angle associated with a selected measurement geometry, for example the delta aspecular angle associated with 25°, to the delta aspecular angle associated with the following selected measurement geometry, in this case the delta aspecular angle associated with 15° and repeating this step for each measurement geometry in the ordered list.

The modified digital representation of the reference coating is generated by modifying at least part of the appearance data contained in the provided digital representation of the reference coating with regard to lightness, darkness, color, texture, gloss, clearcoat appearance or a combination thereof.

In one example, modifying at least part of the appearance data includes using predefined color space distance values, in particular dL, da, db, dC, CH, and/or texture distance values. The appearance data of the modified reference coatings can be obtained by determining modified appearance data using the appearance data contained in the provided digital representation of the reference coating and the predefined color space distance values dL, da and db or dL, dC and dH in combination with well-known color tolerance equations, such as the in particular the Delta E (CIE 1994) color tolerance equation, the Delta E (CIE 2000) color tolerance equation, the Delta E (DIN 99) color tolerance equation, the Delta E (CIE 1976) color tolerance equation, the Delta E (CMC) color tolerance equation, the Delta E (Audi95) color tolerance equation, the Delta E (Audi2000) color tolerance equation or other color tolerance equations. Additional use a color tolerance equation, in particular the Audi95 or Audi2000 color tolerance equation, may be beneficial to achieve standardized offsets of the modified appearance data from the appearance data of the reference coating over the whole color space because the color space values are weighted according to the color and the measurement geometry.

Modification of at least part of the appearance data of the reference coating using predefined color space distance values allows to obtain modified appearance display data appearing greener or redder or bluer or yellower or darker or brighter or less chromatic or more chromatic or having a positive hue shift or having a negative hue shift if displayed within the user interface on the display.

Modification of at least part of the appearance data of the reference coating layer using predefined texture distance values allows to obtain modified appearance display data appearing less sparkling or more sparkling or finer or coarser if displayed within the user interface on the display.

In another example, modifying at least part of the appearance data includes adding a predefined appearance layer to at least part of the appearance data. Modification of the at least part of the appearance data of the reference coating layer by adding a predefined appearance layer, in particular a predefined clearcoat appearance layer, allows to obtain a display images appearing glossier or less glossy or having a higher or lower orange peel.

If at least one L* value within the modified digital representation of the reference coating is greater than 90, preferably greater than 95 or 99, all L* values included in the modified digital representation are scaled using at least one lightness scaling factor si to generate a modified scaled digital representation. Use of this scaling factor allows to retain the color information contained in the gloss measurement geometries by compressing the color space while the existing color distances are kept constant. If no color space compression would be performed, L* values of more than 90, preferably of more than 95, in particular of more than 99, would be displayed with a cropped hue as almost or purely white, i.e. devoid of equidistancy of color information which may be present in the a* and b* values associated with these L* values. The lightness scaling factor s_{L} may be based on the maximum measured L* value of the CIEL*a*b* values included in the modified digital representation.

In one example, calculating corresponding color data, in particular CIEL*a*b* values, for each pixel in each created image includes correlating one axis of each created image with the generated ordered list of measurement geometries and mapping the ordered list of measurement geometries and associated modified digital representation or modified scaled digital representation, in particular the associated modified color values or modified scaled color values, to the correlated row in the created image. An interpolation method, in particular a spline interpolation method, may be used to calculate the intermediate CIEL*a*b* values, i.e. the CIEL*a*b* values for pixels which are not associated with measured geometries, to obtain smooth transitions between CIEL*a*b* values for pixels associated with a measured geometry and intermediate CIEL*a*b* values. The calculated CIEL*a*b* values may be converted into sRGB values and optionally stored on a data storage medium, in particular the internal memory of the computing device. Conversion of the calculated CIEL*a*b* values to sRGB values allows to display the calculated color information with commonly available displays which use sRGB files to display information.

A texture layer may be added to the generated color image(s) to provide spatially resolved texture information (e.g. distribution, size distribution, lightness distribution) or information on the texture color. This may be preferred if the reference coating is an effect coating containing a visible texture. The lightness scaling factor S_{L} used during addition of the texture layer preferably corresponds to the lightness scaling factor si used during generation of the color image(s), i.e. the same lightness scaling factor S_{L} is preferably used, or is set to 1 in case no lightness scaling factor S_{L} is used during the generation of the color image(s). Use of the same lightness scaling factor S_{L} allows to adjust the lightness of the texture image to the lightness of the color image, thus preventing a mismatch of the color and texture information with respect to lightness. The aspecular-dependent scaling function sf_{aspecular} used during addition of the texture layer weights each pixel of the texture layer in correlation with the aspecular angles corresponding to the measurement geometries present in generated ordered list of measurement geometries. This allows to weight the pixels of the texture layer in correlation with the visual impression of the effect coating layer under different measurement geometries and therefore results in generated appearance data closely resembling the visual impression of the effect coating layer when viewed from different viewing angles by an observer. In general, the visual texture, i.e. the coarseness characteristics and the sparkle characteristics, is more prominent in the gloss measurement geometries than in the flop geometries. To take this into account, the aspecular-dependent scaling function sf_{aspecular} preferably outputs scaling factors S_{aspec} close to 1 for gloss measurement geometries and scaling factors S_{aspec} close to 0 for flop measurement geometries.

The texture layer may be added pixel-wise by
providing at least one acquired or synthetic texture image,
generating modified texture image(s) by computing the average color of each provided acquired or synthetic texture image and subtracting the average color from the respective provided acquired or synthetic texture image, and
adding the respective modified texture image pixel-wise weighted with the lightness scaling factor S_{L}, the aspecular dependent scaling function sf_{aspecular} and optionally the contrast scaling factor s_{c} to the respective generated color image.

“Acquired texture image” refers to texture images, such as grey scale or color images, which have been acquired using a multi-angle spectrophotometer as previously described. In contrast, the term “synthetic texture image” refers to a texture image which has been generated from texture characteristics, such as the coarseness and/or sparkle characteristics, determined from the acquired texture images as previously described.

The synthetic texture image can be created by
creating an empty image,
providing a target texture contrast cᵥ,
generating a random number by a uniform or a gaussian random number generator between −cᵥ and +cᵥ for each pixel in the created image and adding the generated random number to each pixel in the created image,
blurring the resulting image using a blur filter, in particular a gaussian blur filter, and
optionally providing the resulting synthetic texture image.

The created empty image preferably has the same resolution as the color image to prevent a mismatch of the texture layer upon addition of the texture layer to the generated color image. This also renders downscaling of the texture layer prior to addition of the said layer to the color image(s) superfluous. The target texture contrast cᵥ preferably corresponds to the sparkle and/or coarseness characteristics or to a predefined value associated with the formulation of the reference coating material. The predefined value may be retrieved from a database based on the formulation of the reference coating material, for example based on the type and/or amount of effect pigments being present in the formulation of the reference coating material.

To facilitate selection of the perceived deviation of the sample coating from the reference coating, the user interface may further comprise at least one display image of the reference coating. This allows the user to better determine the observed deviation(s) because the comparison of the prepared sample coating with the existing reference coating is mimicked within the user interface. With preference, the at least one display image of the reference coating is displayed adjacent to at least part of the modified display images. With particular preference, a display image of the reference coating is displayed adjacent to each modified display image. This allows to display deviations of the reference coating in two directions, for example more or less chromaticity, by displaying the display image of the reference coating in between the modified display images, for example the modified display image being more chromatic and the modified display image being less chromatic than the reference coating. The display images of the reference coating can be generated as previously described for the modified display images by using the digital representation of the reference coating to generate the color image(s).

The provided user interface can be obtained, for example, by
providing via a communication interface to the processor of the computing device a digital representation of the reference coating including appearance data determined at one or more measurement geometries;
optionally generating—with the processor-appearance display data of the reference coating based on the provided digital representation;
optionally displaying a user interface comprising at least one category being indicative of a visual deviation of the sample coating from the reference coating and detecting a user input being indicative of selecting a category;
generating—with the processor-modified appearance display data of the reference coating based on the provided digital representation and optionally the detected user input; and
generating a user interface presentation that presents the generated modified appearance display data as display image(s) of the modified reference coating and optionally the generated appearance display data as display image of the reference coating and displaying the generated user interface presentation.

The term “appearance display data” refers to appearance data that is used to present the appearance of the reference coating as display image(s). The appearance display data and modified appearance display data is preferably generated as previously described.

The user input is preferably provided by an input device. “Input device” may refer to any device that provides an input signal in response to a user input, i.e. that allows a user to perform an input and, in response to that user input, provides an input signal to the computer system being indicative of the user input. Suitable input devices include a mouse device, touch-sensitive surface, a keyboard, etc. In one example, the touchscreen is present within the display such that the display device also functions as input device. The user input is detected by a processor present within the display device and provided to the processor of the computing device via a communication interface. In another example, the input device is present separate from the display device. In this case, the input device is connected to computing device via a communication interface to allow detection of the user input by the processor of said computing device.

After detecting the user input as previously described, the digital representation of the visual assessment of the sample coating is generated by assigning at least one human-perceived attribute to the sample coating based on the detected user input. This may include determining which modified display image(s) was/were selected by the user and assigning at least one human-perceived attribute to the sample coating based on said determination. Generating the digital representation of the visual assessment of the sample coating may further include interrelating the assigned human-perceived attribute with data being indicative of the sample coating and the reference coating. Data being indicative of the sample coating and the reference coating may include, for example, the color name, color number, bar code, QR code, unique database ID of the sample coating and the reference coating, respectively.

Assigning at least one human-perceived attribute to the sample coating in response to the detected user input may include mapping the deviation(s) associated with the detected user input to respective human-perceived attribute(s). Thus, the deviation(s) associated with the modified display image selected by the user are mapped to the respective human-perceived attribute(s) to allow assigning of the human-perceived attributes to the sample coating. The deviation(s) associated with the modified display images can be determined by determining the modified display image selected by the user and identifying the associated deviation(s). The mapping may be performed using a mapping table in which each deviation, such as, for example, dL+2, is assigned to a respective human-perceived attribute, for example lighter.

The generated digital representation of the visual assessment of the sample coating is provided via the communication interface to the computer processor. The assigned human-perceived attributes may be interrelated with information on the sample coating, such as the sample coating ID, and may be stored on a data storage medium, for example a database, prior to providing said data as digital representation to the computer processor.

### Step (ii):

In step (ii) of the inventive method, the computer processor determines if the adjusted sample coating improves at least one human-perceived attribute assigned to the sample coating based on the digital representations provided in step (i).

In an aspect, step (ii) includes
(il-1) determining appearance difference(s) based on the provided digital representations of the sample coating and the reference coating,
(il-2) determining whether at least one human-perceived attribute can be mapped to the determined appearance difference(s), and
(il-3) in accordance with the determination that at least one human-perceived attribute can be mapped to the determined appearance difference(s), determining if the adjusted sample coating improves at least one human-perceived attribute assigned to the sample coating or in accordance with the determination that at least one human-perceived attribute cannot be mapped to the determined appearance difference(s), proceeding to optional step (iii) and/or further steps.

Performing steps (ii-1) to (ii-3) ensures that the visually perceived difference between the sample coating and the reference coating matches the objectively present differences based on the measured appearance, thus resulting in a more robust proposal of an adjusted sample coating which reduces or removes the visually perceived differences between the sample coating and the reference coating. In case the visually perceived difference cannot be matched with the measured appearance difference, the adjusted sample coating will not result in reduction or removal of the visually perceived differences because the adjusted sample coating was calculated using said measured appearance difference. In that case, the inventive method may proceed to optional step (iii) and/or further steps described below, i.e. the inventive method provides the result of the determination performed in step (ii-2) via the communication interface and/or determines at least one further sample coating as described in relation to further steps below.

The appearance difference(s) may be determined by determining color difference value(s), sparkle difference values, coarseness difference values, gloss difference values, longwave difference values, shortwave difference values, DOI difference values or a combination thereof.

In an aspect, determining if the adjusted sample coating improves at least one human-perceived attribute assigned to the sample coating includes
determining the human-perceived attributes assigned to the sample coating based on the provided digital representation of the visual assessment of the sample coating,
determining—for each determined human-perceived attribute—the difference between the adjusted sample coating and the reference as well as the difference between the sample coating and the reference coating based on the provided digital representations of the adjusted sample coating, the sample coating and the reference coating, and
determining—for each determined human-perceived attribute-if the difference between the adjusted sample coating and the reference coating is less than the difference between the sample coating and the reference coating.

Determining the human-perceived attributes assigned to the sample coating may include retrieving the human-perceived attributes stored in the provided digital representation of the visual assessment.

In one example, the difference between the adjusted sample coating and the reference as well as the difference between the sample coating and the reference coating for each determined human-perceived attribute is determined by calculating the average attribute of each measurement geometry and determining the absolute value for each calculated average. The term “attribute” refers to the color, the lightness, the darkness, the texture, the gloss or the clearcoat appearance. For example, the difference between the adjusted sample coating and the reference coating as well as the difference between the sample coating and the reference coating in terms of color can be determined by calculating the average dL, da, db and/or dE of each measurement geometry and then determining the absolute value for each calculated average.

In one example, the difference between the sample coating and the reference coating for each determined human-perceived attribute includes subtracting a term being indicative of the significance from the difference between the sample coating and the reference coating. The term being indicative of the significance can either be a predefined term or can be derived from the overall rating selected by the user as described previously, i.e. the lower the overall rating, the higher the term being indicative of the significance. Such correlation can be predefined, for example by defining terms being indicative of the significance for each overall rating selectable by the user and retrieving the respective term based on the detected user input. Use of said term being indicative of a significance allows to determine whether the adjusted sample coating significantly improves the visually perceived difference of the user such that proposed adjusted sample coatings can be expected to result in a better visual appearance match.

Optional Step (iii):

In step (iii), the result of the determination performed in step (ii) is provided via the communication interface, this step being generally optional. The result may be provided to a display device for display to a user. Performing said step may be preferred if the result of the determination is to be provided to the user, for example within a graphical user interface. Omitting said step may be preferred if further steps are performed, for example the further steps described in the following.

### Further Steps:

Apart from steps (i) and (ii) and optional step (iii), the inventive method may comprise further steps.

In an aspect, the inventive method further comprises a step (iv) of
providing the digital representation of the adjusted sample coating, in particular the formulation of the adjusted sample coating, via the communication interface in accordance with the determination that the adjusted sample coating improves at least one human-perceived attribute assigned to the sample coating, or
determining at least one further sample coating based on the provided digital representation of the reference coating and providing the determined further sample coating(s) via the communication interface in accordance with the determination that the adjusted sample coating does not improve at least one human-perceived attribute assigned to the sample coating.

In case step (iii) is performed, step (iv) may be performed prior or after step (iv).

The digital representation of the adjusted sample coating may be provided via the communication interface. In one example, this includes providing the adjusted sample coating formulation, such as the exact formulation or a mixing formula which can be used to prepare the adjusted sample coating formulation, to a display device for display within a graphical user interface. In addition or alternatively, the digital representation of the adjusted sample coating can be provided to a data storage medium.

In case the adjusted sample coating does not improve at least one human-perceived attribute assigned to the sample coating, the adjusted sample coating may not be displayed to the user, because said adjusted sample coating does not provide a better match in terms of appearance than the already prepared sample coating. In this case, at least one further sample coating (i.e. a sample coating being different from the sample coating already prepared by the user) may be determined. The further sample coating may be determined with a further computing resource being present separate from the computer processor implementing the methods disclosed herein.

In one example, determining at least one further sample coating includes determining at least one best matching sample coating based on the provided digital representation of the reference coating and providing said best matching sample coating(s) as further sample coating(s) via the communication interface.

The at least one best matching sample coating can be determined based on the provided digital representation of the reference coating by determining with the computer processor best matching colorimetric values, in particular best matching CIEL*a*b* values. In one example, the computer processor determining best matching colorimetric values, in particular CIEL*a*b* values, is the computer processor used in steps (ii) and (iii). In another example, the computer processor determining best matching colorimetric values is a different computer processor, such as a computer processor located in a further computing device. The further computing device may be a stationary local computing device or may be located in a cloud environment as previously described. Use of a further computing device to determine best matching colorimetric values allows to shift the steps requiring high computing power to external computing devices, thus allowing to use display devices with low computing power without unreasonably prolonging the generation and display of appearance data on the screen of the display device.

Best matching colorimetric values, in particular CIEL*a*b* values, may be determined by determining best matching sample coating(s) and associated matching CIEL*a*b* values, calculating the color differences between the determined CIEL*a*b* values and each matching CIEL*a*b* values to define color difference values and determine if the color difference values are acceptable. The best matching sample coatings(s) and associated matching CIEL*a*b* values may be determined by searching a database for the best matching sample coatings(s) based on the measured CIEL*a*b* values. In one example, the acceptability of the color difference values can be determined using a data driven model parametrized on historical colorimetric values, in particular CIEL*a*b* values, and historical color difference values. Such models are described, for example, in US 2005/0240543 A1. In another example, a commonly known color tolerance equation, such as the CIE94 color tolerance equation, the CIE2000 color tolerance equation, the DIN99 color tolerance equation or a color tolerance equation described in WO 2011/048147 A1, is used to determine the color difference values. In another example, determining at least one further sample coating includes providing matching sample coatings identified in a previous color matching operation, such as a previous database search used to identify the prepared sample coating. This may include removing the sample coating previously selected to avoid repetitive selection of the previously selected sample coating.

In yet another example, determining at least one further sample coating includes providing application parameters used to prepare the sample coating and determining at least one further sample coating based on the provided application parameters and the digital representation of the sample coating, in particular the appearance data of the sample coating. The application parameters may be provided by monitoring said parameters during application of the sample coating and providing said monitored application parameters via a communication interface. Determination of the at least one further sample coating may be performed with the computer processor performing steps (ii) and (iii) or with a different computer processor. The at least one further sample coating may be determined based on the provided application parameters and appearance data as described in unpublished EP patent application EP 20213635.4.

The digital representation of the adjusted sample coating or the further sample coating(s) may be provided via the communication interface to a display device for display on the within a graphical user interface. The display device may be the same display device described in relation to step (ii) above. With preference, the formulation of the adjusted sample coating or the further sample coating(s) along with further data, such as the mixing formula which can be used to prepare the adjusted sample coating formulation or the further sample coating formulation(s) from commercially available products, the color ID, the color name, the matching score, etc. may be displayed within the GUI.

In one example, providing the digital representation of the adjusted sample coating and/or the further sample coating(s) to the display device includes generating appearance display data for the adjusted sample coating and/or the further sample coating(s) and optionally the reference coating and providing the generated appearance display data, optionally in combination with further data, to the display device for display within the GUI. The appearance display data can be generated using the method previously described in relation to step (i). Displaying a display image of the adjusted sample coating or the further sample coating(s) on the screen of the display device, preferably positioned adjacent to a display image of the reference coating, allows the user to visually compare the appearance of the adjusted sample coating or the further sample coating(s) with the reference coating to determine whether the adjusted sample coating or any one of the further sample coating(s) results in a sufficient match in terms of appearance.

In addition to or instead of providing the digital representation of the adjusted sample coating or the further sample coating(s) via the communication interface, the digital representation of the adjusted sample coating or the further sample coating(s) can be provided to a data storage medium, such as a database. This may include interrelating the digital representation of the adjusted sample coating or the further sample coating(s) with a unique ID and storing the digital representation of the adjusted sample coating or the further adjusted sample coating(s) interrelated with the unique ID on the data storage medium. Use of the unique ID allows to retrieve the stored information from the data storage medium.

In an aspect, steps (ii) and (iv) are performed simultaneously. “Simultaneously” refers to the time it takes the computer processor to perform steps (ii) and (iv) and the display device to display the generated appearance data. Preferably, the time is small enough such that determination whether the adjusted sample coating improves at least one human-perceived attribute and providing the adjusted sample coating or at least one further sample coating is performed ad-hoc, i.e. within a few milliseconds after initiating step (ii).

### Embodiments of the Inventive Apparatus

In an aspect, the inventive apparatus further comprises, apart from the display, the one or more computing nodes and the one or more computer-readable media, at least one appearance measurement device. The term “appearance measurement device” refers to any measurement device which is suitable to acquire data on the appearance, such as the color, the texture, the gloss and/or the clearcoat appearance, of a coating. Such suitable measurement devices include cameras, for example smartphone cameras or other color cameras, single-angle or multi-angle spectrophotometers, gloss meters and measurement devices for determining orange peel (i.e. shortwave and longwave values) and DOI.

In an aspect, the inventive apparatus further comprises at least one database containing the digital representations of sample coatings and reference coatings. The database is preferably connected via a communication interface with the one or more computing nodes to allow retrieval of respective digital representations from the database by the one or more computing nodes.

### Embodiments of the Inventive Client Device

In an aspect, the server device is configured to determine the digital representation of the adjusted sample coating based on the provided digital representation of the sample coating and the reference coating, and/or to determine the digital representation of the visual assessment of the sample coating, and to perform steps (ii) and optionally (iii) of the inventive method. In one example, the server device is also configured to perform further step (iv) of the inventive method. Use of the server device to perform all determinations requiring high computing power allows to use display devices having low computing power, because said display devices are merely used to display the user interface presentations generated by the server device. The digital representation of the visual assessment of the sample coating can be generated by the server device from data of the detected user input provided by the client device, for example via HTTP protocols.

### BRIEF DESCRIPTION OF THE DRAWINGS

These and other features of the present invention are more fully set forth in the following description of exemplary embodiments of the invention. To easily identify the discussion of any particular element or act, the most significant digit or digits in a reference number refer to the figure number in which that element is first introduced. The description is presented with reference to the accompanying drawings in which:

FIGS. 1A,B illustrate example embodiments of a centralized and a decentralized computing environment with computing nodes.

FIG. 1C illustrates an example embodiment of a distributed computing environment.

FIG. 2 illustrates a flow diagram of a computer-implemented method for determining at least one adjusted sample coating to match the appearance of a reference coating in accordance with a first embodiment of the invention.

FIG. 3 illustrates a flow diagram of a computer-implemented method for determining at least one adjusted sample coating to match the appearance of a reference coating in accordance a second embodiment of the invention.

FIG. 4 illustrates a flow diagram of an embodiment of generating the digital representation of the sample coating provided in FIGS. 2 and 3 in accordance with implementations of the invention.

FIG. 5 illustrates a flow diagram of an embodiment of generating the digital representation of the adjusted sample coating provided in FIGS. 2 and 3 in accordance with implementations of the invention.

FIG. 6A illustrates a flow diagram of an embodiment of generating the digital representation of the visual assessment of the sample coating provided in FIGS. 2 and 3 in accordance with implementations of the invention.

FIG. 6B illustrates a flow diagram illustrating of an embodiment of the user interface provided in FIG. 6A in accordance with implementations of the invention.

FIG. 7A illustrates a flow diagram of an embodiment of generating appearance display data of the reference coating and/or the sample coating and/or the adjusted sample coating and/or further sample coating(s) in accordance with implementations of the invention.

FIGS. 7B-7D illustrates a flow diagram illustrating of an embodiment of modified appearance display data of the reference coating described in block 616 or 622 of FIG. 6B in accordance with implementations of the invention.

FIG. 8 illustrates a planar view of a display comprising a graphical user interface used to generate the visual assessment of the sample coating according to implementations of the invention.

FIG. 9 illustrates a planar view of a display comprising a graphical user interface populated with appearance display data of a reference effect coating, appearance data of a sample coating and appearance display data of an adjusted sample coating determined to improve at least one human-perceived attribute according to implementations of the invention.

FIG. 10 illustrates a planar view of a display comprising a graphical user interface populated with appearance display data of a reference effect coating and appearance display data of further sample coatings retrieved from a database according to implementations of the invention.

### DETAILED DESCRIPTION

The detailed description set forth below is intended as a description of various aspects of the subject-matter and is not intended to represent the only configurations in which the subject-matter may be practiced. The appended drawings are incorporated herein and constitute a part of the detailed description. The detailed description includes specific details for the purpose of providing a thorough understanding of the subject-matter. However, it will be apparent to those skilled in the art that the subject-matter may be practiced without these specific details.

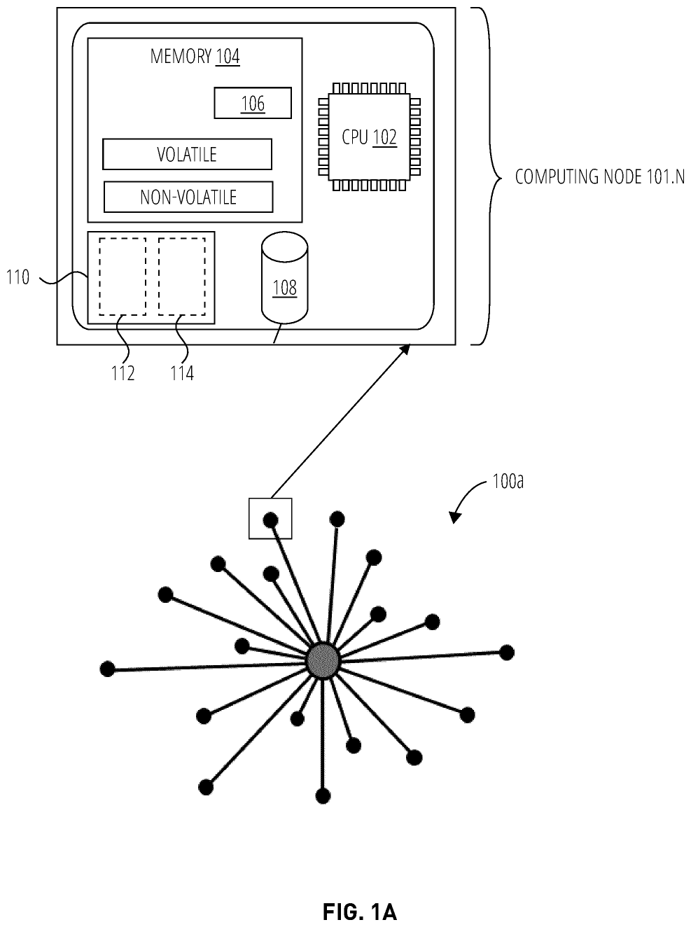

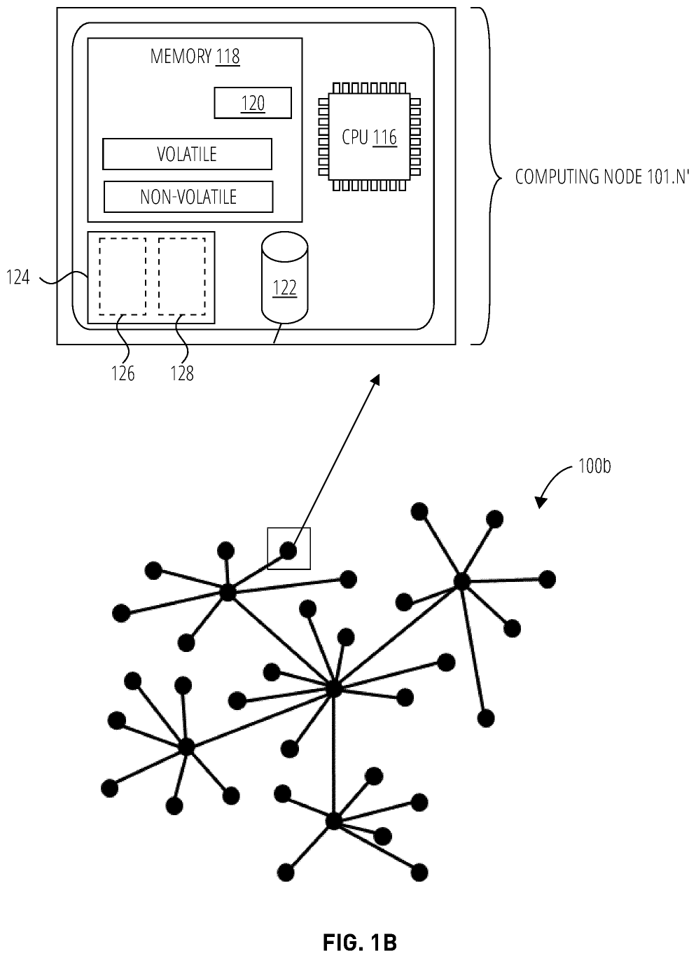

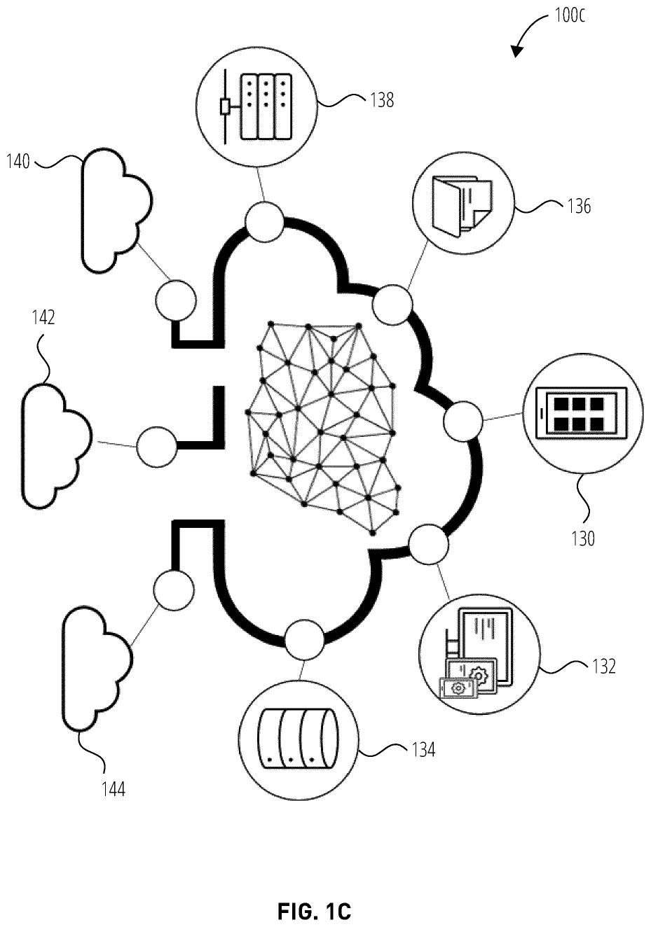

Some figures describe the inventive method in flowchart form. In this form, certain operations are described as constituting distinct blocks performed in a certain order. Such implementations are illustrative and non-limiting. Certain blocks described herein can be grouped together and performed in a single operation, certain blocks can be broken apart into plural component blocks, and certain blocks can be performed in an order that differs from that which is illustrated herein (including a parallel manner of performing the blocks). In one implementation, the blocks shown in the flowcharts that pertain to processing-related functions can be implemented by the hardware logic circuitry described in relation to FIGS. 1a to 1c, which, in turn, can be implemented by one or more hardware processors and/or other logic components that include a task-specific collection of logic gates.

Any of the storage resources described herein, or any combination of the storage resources, may be regarded as a computer-readable medium. In many cases, a computer-readable medium represents some form of physical and tangible entity. The term computer-readable medium also encompasses propagated signals, e.g., transmitted or received via a physical conduit and/or air or other wireless medium, etc. However, the specific term “computer-readable storage medium” expressly excludes propagated signals per se, while including all other forms of computer-readable media.

The following explanation may identify one or more features as “optional.” This type of statement is not to be interpreted as an exhaustive indication of features that may be considered optional; that is, other features can be considered as optional, although not explicitly identified in the text. Further, any description of a single entity is not intended to preclude the use of plural such entities; similarly, a description of plural entities is not intended to preclude the use of a single entity. Further, while the description may explain certain features as alternative ways of carrying out identified functions or implementing identified mechanisms, the features can also be combined together in any combination. Finally, the terms “exemplary” or “illustrative” refer to one implementation among potentially many implementations.

FIGS. 1A to 1C illustrate different computing environments, central, decentral and distributed. The methods, apparatuses and computer elements of this disclosure may be implemented in decentral or at least partially decentral computing environments. This may be preferred in case data sharing or exchange is performed in ecosystems comprising multiple players.

FIG. 1A illustrates an example embodiment of a centralized computing system 100a comprising a central computing node 101 (gray circle in the middle) and several peripheral computing nodes 101.1 to 101.n (denoted as filled black circles in the periphery). The term “computing system” is defined herein broadly as including one or more computing nodes, a system of nodes or combinations thereof. The term “computing node” is defined herein broadly and may refer to any device or system that includes at least one physical and tangible processor, and a physical and tangible memory capable of having thereon computer-executable instructions that are executed by a processor. Computing nodes are now increasingly taking a wide variety of forms. Computing nodes may, for example, be handheld devices, production facilities, sensors, monitoring systems, control systems, appliances, laptop computers, desktop computers, mainframes, data centers, or even devices that have not conventionally been considered a computing node, such as wearables (e.g., glasses, watches or the like). The memory may take any form and depends on the nature and form of the computing node.

In this example, the peripheral computing nodes 101.1 to 101.n may be connected to one central computing system (or server). In another example, the peripheral computing nodes 101.1 to 101.n may be attached to the central computing node via a terminal server (not shown). The majority of functions may be carried out by, or obtained from, the central computing node (also called remote centralized location). One peripheral computing node 101.n has been expanded to provide an overview of the components present in the peripheral computing node. The central computing node 101 may comprise the same components as described in relation to the peripheral computing node 101.n.

Each computing node 101, 101.1 to 101.n may include at least one hardware processor 102 and memory 104. The term “processor” may refer to an arbitrary logic circuitry configured to perform basic operations of a computer or system, and/or, generally, to a device which is configured for performing calculations or logic operations. In particular, the processor, or computer processor may be configured for processing basic instructions that drive the computer or system. It may be a semi-conductor based processor, a quantum processor, or any other type of processor configures for processing instructions. As an example, the processor may comprise at least one arithmetic logic unit (“ALU”), at least one floating-point unit (“FPU)”, such as a math coprocessor or a numeric coprocessor, a plurality of registers, specifically registers configured for supplying operands to the ALU and storing results of operations, and a memory, such as an L1 and L2 cache memory. In particular, the processor may be a multicore processor. Specifically, the processor may be or may comprise a Central Processing Unit (“CPU”). The processor may be a (“GPU”) graphics processing unit, (“TPU”) tensor processing unit, (“CISC”) Complex Instruction Set Computing microprocessor, Reduced Instruction Set Computing (“RISC”) microprocessor, Very Long Instruction Word (“VLIW”) microprocessor, or a processor implementing other instruction sets or processors implementing a combination of instruction sets. The processing means may also be one or more special-purpose processing devices such as an Application-Specific Integrated Circuit (“ASIC”), a Field Programmable Gate Array (“FPGA”), a Complex Programmable Logic Device (“CPLD”), a Digital Signal Processor (“DSP”), a network processor, or the like. The methods, systems and devices described herein may be implemented as software in a DSP, in a micro-controller, or in any other side-processor or as hardware circuit within an ASIC, CPLD, or FPGA. It is to be understood that the term processor may also refer to one or more processing devices, such as a distributed system of processing devices located across multiple computer systems (e.g., cloud computing), and is not limited to a single device unless otherwise specified.

The memory 104 may refer to a physical system memory, which may be volatile, non-volatile, or a combination thereof. The memory may include non-volatile mass storage such as physical storage media. The memory may be a computer-readable storage media such as RAM, ROM, EEPROM, CD-ROM, or other optical disk storage, magnetic disk storage, or other magnetic storage devices, or any other physical and tangible storage medium which can be used to store desired program code means in the form of computer-executable instructions or data structures and which can be accessed by the computing system. Moreover, the memory may be a computer-readable media that carries computer-executable instructions (also called transmission media). Further, upon reaching various computing system components, program code means in the form of computer-executable instructions or data structures can be transferred automatically from transmission media to storage media (or vice versa). For example, computer-executable instructions or data structures received over a network or data link can be buffered in RAM within a network interface module (e.g., a “NIC”), and then eventually transferred to computing system RAM and/or to less volatile storage media at a computing system. Thus, it should be understood that storage media can be included in computing components that also (or even primarily) utilize transmission media.

The computing nodes 101, 101.1 . . . 101.n may include multiple structures 106 often referred to as an “executable component or computer-executable instructions”. For instance, memory 104 of the computing nodes 101, 101.1 . . . 101.n may be illustrated as including executable component 106. The term “executable component” may be the name for a structure that is well understood to one of ordinary skill in the art in the field of computing as being a structure that can be software, hardware, or a combination thereof or which can be implemented in software, hardware, or a combination. For instance, when implemented in software, one of ordinary skill in the art would understand that the structure of an executable component include software objects, routines, methods, and so forth, that is executed on the computing nodes 101, 101.1 . . . 101.n, whether such an executable component exists in the heap of a computing node 101, 101.1 . . . 101.n, or whether the executable component exists on computer-readable storage media. In such a case, one of ordinary skill in the art will recognize that the structure of the executable component exists on a computer-readable medium such that, when interpreted by one or more processors of a computing node 101, 101.1 . . . 101.n (e.g., by a processor thread), the computing node 101, 101.1 . . . 101n is caused to perform a function. Such a structure may be computer-readable directly by the processors (as is the case if the executable component were binary). Alternatively, the structure may be structured to be interpretable and/or compiled (whether in a single stage or in multiple stages) so as to generate such binary that is directly interpretable by the processors. Such an understanding of example structures of an executable component is well within the understanding of one of ordinary skill in the art of computing when using the term “executable component”. Examples of executable components implemented in hardware include hardcoded or hard-wired logic gates, that are implemented exclusively or near-exclusively in hardware, such as within a field-programmable gate array (FPGA), an application-specific integrated circuit (ASIC), or any other specialized circuit. In this description, the terms “component”, “agent”, “manager”, “service”, “engine”, “module”, “virtual machine” or the like are used synonymous with the term “executable component.

The processor 102 of each computing node 101, 101.1 . . . 101.n direct the operation of each computing node 101, 101.1 . . . 101.n in response to having executed computer-executable instructions that constitute an executable component. For example, such computer-executable instructions may be embodied on one or more computer-readable media that form a computer program product. The computer-executable instructions may be stored in the memory 104 of each computing node 101, 101.1 . . . 101.n. Computer-executable instructions comprise, for example, instructions and data which, when executed at a processor 101, cause a general purpose computing node 101, 101.1 . . . 101.n, special purpose computing node 101, 101.1 . . . 101.n, or special purpose processing device to perform a certain function or group of functions. Alternatively or in addition, the computer-executable instructions may configure the computing node 101, 101.1 . . . 101.n to perform a certain function or group of functions. The computer executable instructions may be, for example, binaries or even instructions that undergo some translation (such as compilation) before direct execution by the processors, such as intermediate format instructions such as assembly language, or even source code.

Each computing node 101, 101.1 . . . 101.n may contain communication channels 108 that allow each computing node 101.1 . . . 101.n to communicate with the central computing node 101, for example, a network (depicted as solid line between peripheral computing nodes and the central computing node in FIG. 1a). A “network” may be defined as one or more data links that enable the transport of electronic data between computing nodes 101, 101.1 . . . 101.n and/or modules and/or other electronic devices. When information is transferred or provided over a network or another communications connection (either hardwired, wireless, or a combination of hardwired or wireless) to a computing node 101, 101.1 . . . 101.n, the computing node 101, 101.1 . . . 101.n properly views the connection as a transmission medium. Transmission media can include a network and/or data links which can be used to carry desired program code means in the form of computer-executable instructions or data structures and which can be accessed by a general-purpose or special-purpose computing nodes 101, 101.1 . . . 101.n. Combinations of the above may also be included within the scope of computer-readable media.

The computing node(s) 101, 101.1 to 101.n may further comprise a user interface system 110 for use in interfacing with a user. The user interface system 110 may include output mechanisms 112 as well as input mechanisms 114. The principles described herein are not limited to the precise output mechanisms 112 or input mechanisms 114 as such will depend on the nature of the device. However, output mechanisms 112 might include, for instance, displays, speakers, displays, tactile output, holograms and so forth. Examples of input mechanisms 114 might include, for instance, microphones, touchscreens, holograms, cameras, keyboards, mouse or other pointer input, sensors of any type, and so forth.

FIG. 1B illustrates an example embodiment of a decentralized computing environment 100b with several computing nodes 101.1′ to 101.n′ denoted as filled black circles. In contrast to the centralized computing environment 100a illustrated in FIG. 1A, the computing nodes 101.1′ to 101.n′ of the decentralized computing environment 100b are not connected to a central computing node and are thus not under control of a central computing node. Instead, resources, both hardware and software, may be allocated to each individual computing node 101.1′ . . . 101.n′ (local or remote computing system) and data may be distributed among various computing nodes 101.1′ . . . 101.n′ to perform the tasks. Thus, in a decentral system environment, program modules may be located in both local and remote memory storage devices. One computing node 101.N′ has been expanded to provide an overview of the components present in the computing node 101.N′. In this example, the expanded computing node 101′.N comprises the same components as described in relation to FIG. 1A.

FIG. 1C illustrates an example embodiment of a distributed computing environment 100c. In this description, “distributed computing” may refer to any computing that utilizes multiple computing resources. Such use may be realized through virtualization of physical computing resources. One example of distributed computing is cloud computing. “Cloud computing” may refer a model for enabling on-demand network access to a shared pool of configurable computing resources (e.g., networks, servers, storage, applications, and services). When distributed, cloud computing environments may be distributed internationally within an organization and/or across multiple organizations. In this example, the distributed cloud computing environment 100c may contain the following computing resources: mobile device(s) 130, applications 132, databases 134, data storage 136 and server(s) 138. The cloud computing environment 100c may be deployed as public cloud 140, private cloud 142 or hybrid cloud 144. A private cloud 142 may be owned by an organization and only the members of the organization with proper access can use the private cloud 142, rendering the data in the private cloud at least confidential. In contrast, data stored in a public cloud 140 may be open to anyone over the internet. The hybrid cloud 144 may be a combination of both private and public clouds 142, 140 and may allow to keep some of the data confidential while other data may be publicly available.

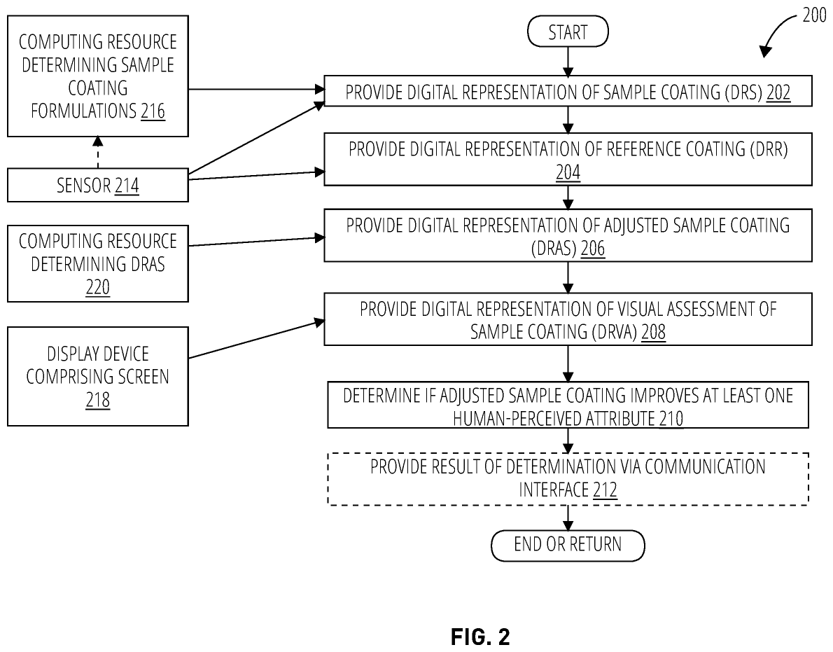

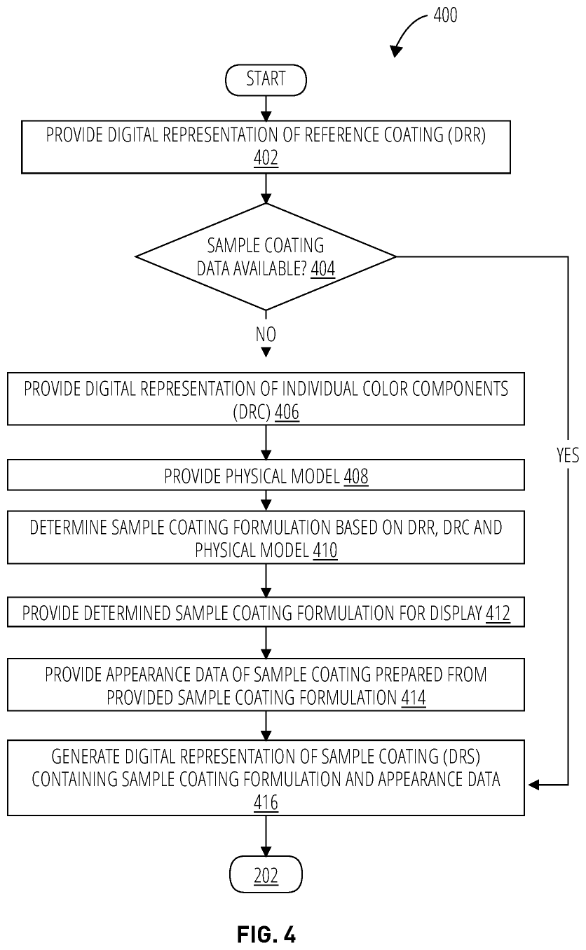

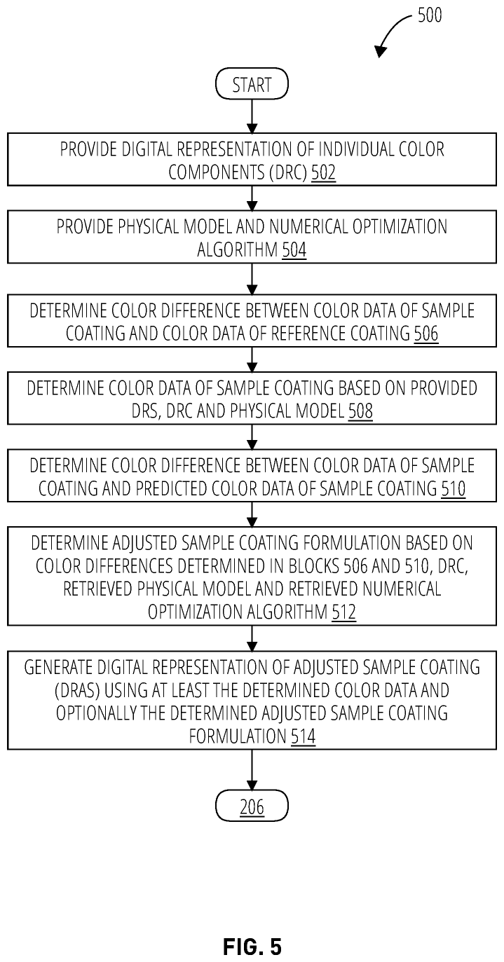

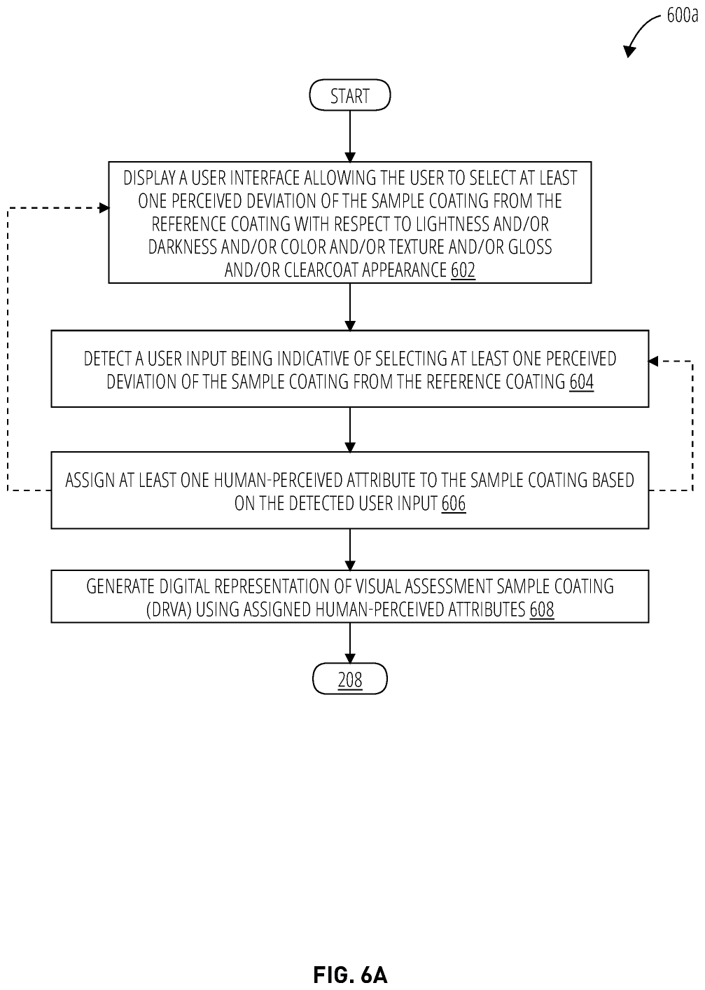

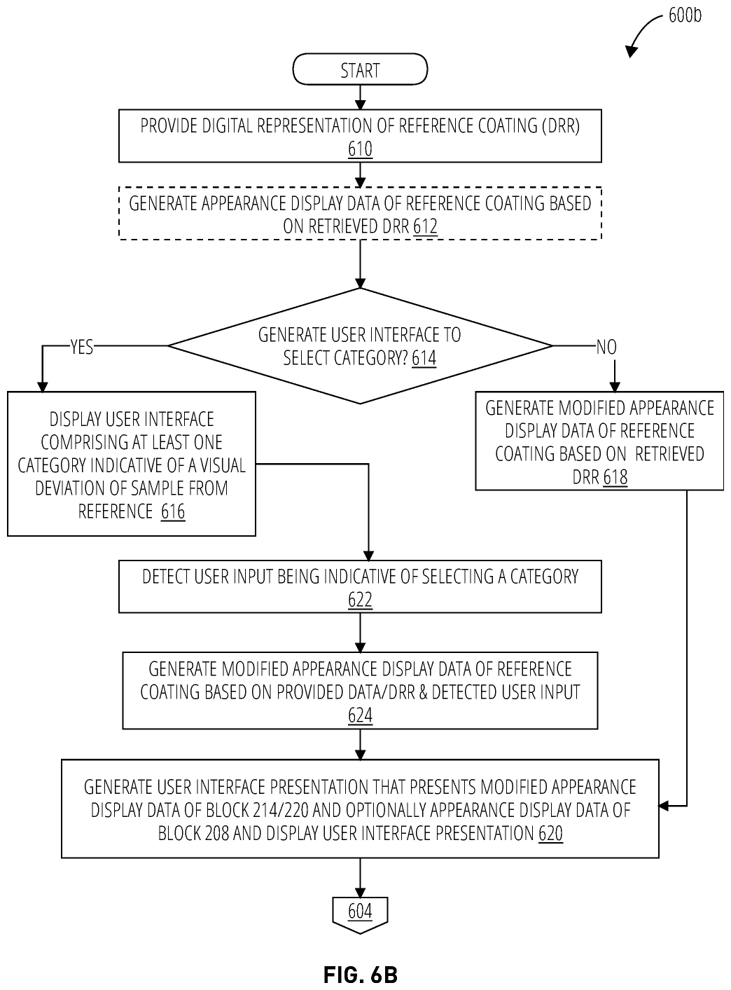

FIG. 2 illustrates a first non-limiting embodiment of a method 200 for determining at least one adjusted sample coating to match the appearance of a reference coating, said method being implemented by a computing device comprising a computer processor. The computing device may be a stationary or a mobile computing device or may be located in a centralized, decentralized or distributed computing environment described in relation to FIGS. 1A to 1C. The computing device may be a mobile device having an LCD display, such as a tablet or laptop. The computing device may be a stationary device, such as a stationary computer. The reference coating and the sample coating may be effect coatings comprising effect pigment(s). The reference coating and the effect coating may be solid shade coatings comprising color pigments but being free of effect pigments. The sample coating may have been prepared by providing a reference coating and determining the appearance of the reference coating. The reference coating may correspond to a multilayer coating comprising one or more damaged areas within the multilayer coating. Appearance data of the reference coating may be determined using one or more sensor(s) 214, such as a multiangle spectrophotometer, a camera, a gloss meter or a combination thereof. Sensor(s) 214 may be part of a distributed computing environment, for example as described in the context of FIG. 1C. The determined appearance data may be provided as digital representation of the reference coating layer to the processor implementing method 200, for example via a communication interface such as an API. The determined appearance data may be provided to a database (not shown) for storage. The determined appearance data may be provided to computing resource 216 configured to determine best matching sample coating formulations using commonly known color matching processes. Computing resource 216 may be configured to perform the method described in the context of FIG. 4. Computing resource 216 may be part of a distributed computing environment, for example as described in the context of FIG. 1C. One of the identified best matching sample coating formulations may be selected and may be used to prepare a sample coating using said selected sample coating formulation and optionally a further clearcoat formulation. Sample coating formulation data associated with the selected sample coating may be provided as part of the digital representation of the sample coating layer to the processor implementing method 200, for example via a communication interface, such as an API. Sample coating formulation data associated with the selected sample coating may be provided to a database (not shown) for storage. The sample coating may be prepared by applying a sample coating material prepared from the selected sample coating formulation and optionally a clearcoat coating material to the surface of a substrate and curing the applied coating materials, either jointly or separately. After preparing the sample coating, the appearance data of the sample coating may be determined using one or more sensor(s) 214 as previously described. The determined appearance data may be provided as part of the digital representation of the sample coating layer to the processor implementing method 200, for example via a communication interface such as an API. The determined appearance data may be provided to a database (not shown) for storage. The prepared sample coating may be visually compared to the reference coating by a user. If the sample coating deviates in terms of appearance from the reference coating, the user may initiate method 200. Initiation of method 200 may trigger determination of the digital representation of the adjusted sample coating by computing resource 220, for example according to the method described in the context of FIG. 5. The determined digital representation of the adjusted sample coating formulation may be provided by computing resource 220 to the processor implementing method 200. Computing resource 220 may be part of a distributed computing environment, for example as described in the context of FIG. 1C. Initiation of method 200 may trigger determination of the digital representation of the visual assessment by display device 218 comprising a screen. The display device 218 may be configured to implement the method described in the context of FIGS. 6A and 6B to determine the digital representation of the visual assessment. The determined digital representation of the visual assessment may be provided to the processor implementing method 200, for example via a communication interface. Display device 218 may be part of a distributed computing environment, for example as described in the context of FIG. 1C.

In block 202, the digital representation of the sample coating (also called DRS hereinafter) may be provided. In this example, the digital representation of the sample coating contains color space data, such as CIEL*a*b* values, and texture data, such as texture images and/or texture characteristics. In another example, the digital representation of the sample coating contains color space data but no texture data, for example if the sample coating is a solid shade coating not comprising any effect pigments. In yet another example, the digital representation of the sample coating contains color space data, texture data, such as texture images and texture characteristics, and gloss data and/or longwave and shortwave values and/or DOI values. In this example, the CIEL*a*b* values of the sample coating are obtained as described previously by measuring the appearance of the sample coating at one or more measurement geometries with a spectrophotometer and determining the CIEL*a*b* values from the acquired data, such as acquired reflectance data. In this example, the CIEL*a*b* values of the sample coating are determined at a plurality of measurement geometries including at least one gloss and at least one non-gloss measurement geometry using a multi-angle spectrophotometer as previously described. The texture characteristics are determined from texture images acquired at defined measurement geometries as previously described. The digital representation of the sample coating can contain further data, such as described previously. The digital representation of the sample coating may be stored on a data storage medium and may be provided from said data storage medium in block 202. The digital representation of the sample coating may be provided by computing resource 216. Computing resource 216 may be configured to generate the digital representation of the sample coating according to the method described in the context of FIG. 4 below and to provide the generated digital representation. The digital representation of the sample coating may be provided by a further computing resource (not shown) configured to gather sample coating formulation data associated with sample coatings determined by computing resource 216 and sensor(s) 214.

In block 204, the digital representation of the reference coating (denoted DRR hereinafter) may be provided. In this example, the digital representation of the reference coating contains color space data, such as CIEL*a*b* values, and texture data, such as texture images and/or texture characteristics. In another example, the digital representation of the reference coating contains color space data but no texture data, for example if the reference coating is a solid shade coating not comprising any effect pigments. In yet another example, the digital representation of the reference coating contains color space data, texture data, such as texture images and texture characteristics, and gloss data and/or longwave and shortwave values and/or DOI values. The digital representation of the reference coating may be provided from a database using reference coating identification data as previously described. The digital representation of the reference coating may be provided by determining appearance data of the reference coating with one or more sensor(s) 214 as described previously. The sensor(s) 214 may be configured to provide the determined appearance data as digital representation of the reference coating to the processor implementing method 200. The digital representation of the reference coating can contain further data, such as described previously.

In block 206, the digital representation of the adjusted sample coating (denoted DRAS hereinafter) may be provided. In this example, the digital representation of the adjusted sample coating contains appearance data of the adjusted sample coating as well as the formulation of the adjusted sample coating. In another example, the digital representation does not contain the formulation of the adjusted sample coating. In this example, the appearance data includes color space data, such as CIEL*a*b* values, and texture data, such as texture characteristics. In another example, the digital representation contains color space data but no texture data, for example if the adjusted sample coating is a solid shade coating not comprising any effect pigments. The digital representation of the adjusted sample coating may be stored on a data storage medium and may be provided using a unique ID interrelated with the DRAS. The digital representation of the adjusted sample coating may be provided by computing resource 220. Computing resource 220 may be configured to generate the digital representation of the sample coating according to the method described in the context of FIG. 5 below and to provide the generated digital representation.

In block 208, a digital representation of the visual assessment of the sample coating (DRVA) may be provided. Providing may include receiving or retrieving said digital representation from a display device 218. The display device may be configured to generate the digital representation according to the method described in the context of FIGS. 6A and 6B and to provide the generated digital representation. In this example, the DRVA contains at least one human-perceived attribute assigned to the sample coating by a human observer, such as the user performing method 200. The DRVA may be generated as previously described by displaying a graphical user interface allowing the user to select a perceived difference between the sample coating and the reference coating and assigning at least one human-perceived attribute to the sample coating based on the detected user input.

In block 210, the routine implementing method 200 may determine whether the adjusted sample coating improves at least one human-perceived attribute. This may include the following steps:
determining the human-perceived attributes assigned to the sample coating based on the digital representation of the visual assessment of the sample coating retrieved in block 208,
determining—for each determined human-perceived attribute—the difference between the adjusted sample coating and the reference coating as well as the difference between the sample coating and the reference coating based on the digital representation of the adjusted sample coating provided in block 206, the digital representation of the sample coating provided in block 202 and the digital representation of reference coating provided in block 204, and
determining—for each determined human-perceived attribute-if the difference between the adjusted sample coating and the reference coating is less than the difference between the sample coating and the reference coating.

The difference between the adjusted sample coating and the reference as well as the difference between the sample coating and the reference coating for each determined human-perceived attribute may be determined by calculating the average attribute of each measurement geometry and determining the absolute value for each calculated average. In this example, a term being indicative of the significance is subtracted from the difference between the reference coating and the sample coating. This allows to determine whether the adjusted sample coating significantly improves at least one human-perceived attribute or not. The term being indicative of the significance can be predefined or can be determined based on the overall rating selected by the user as previously described.

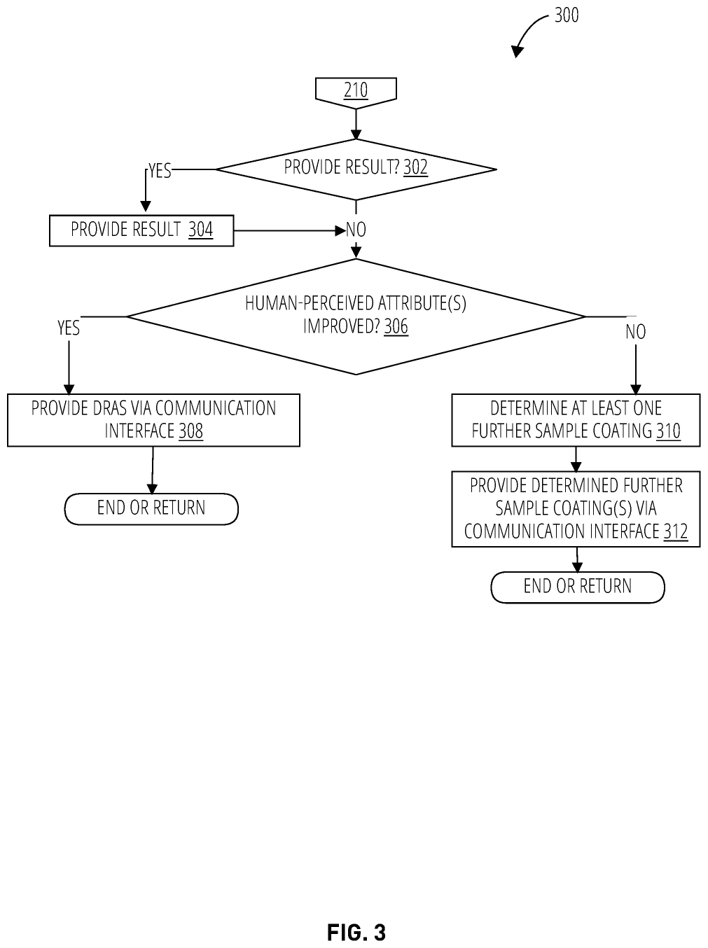

In another example, determining whether the adjusted sample coating improves at least one human-perceived attribute may include the following steps:
determining appearance difference(s) based on the digital representations of the sample coating and the reference coating provided in blocks 202 and 204,
determining whether at least one human-perceived attribute contained in the digital representation provided in block 208 can be mapped to the determined appearance difference(s),
in accordance with the determination that at least one human-perceived attribute can be mapped to the determined appearance difference(s), determining if the adjusted sample coating improves at least one human-perceived attribute assigned to the sample coating or in accordance with the determination that at least one human-perceived attribute cannot be mapped to the determined appearance difference(s), proceeding to block 212 or blocks 320 and 322 described in relation to FIG. 3 below.

Determination of whether the adjusted sample coating improve at least one human-perceived attribute may be performed as described previously. Performing said steps ensures that the visually perceived difference between the sample coating and the reference coating matches the objectively present differences based on the measured appearance, thus resulting in a more robust proposal of an adjusted sample coating which reduces or removes the visually perceived differences between the sample coating and the reference coating.

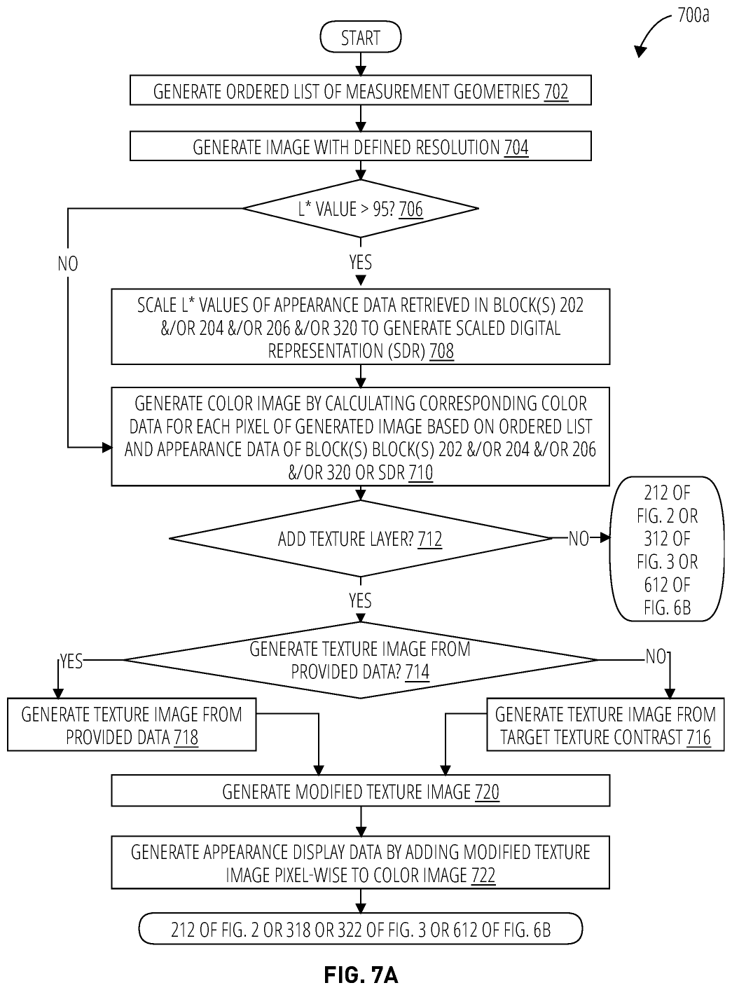

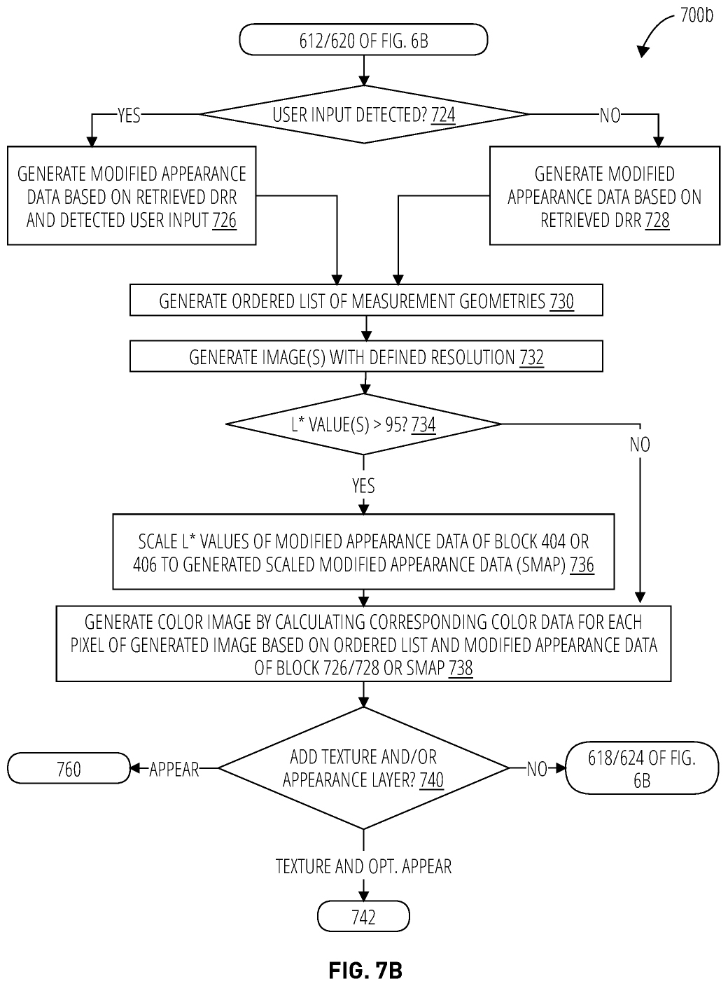

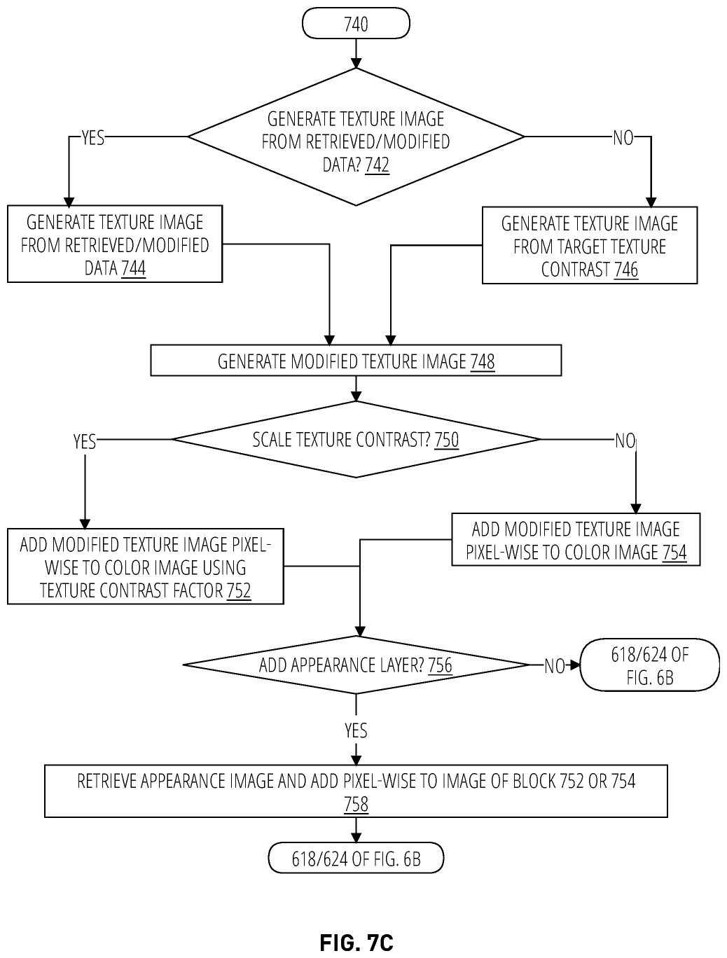

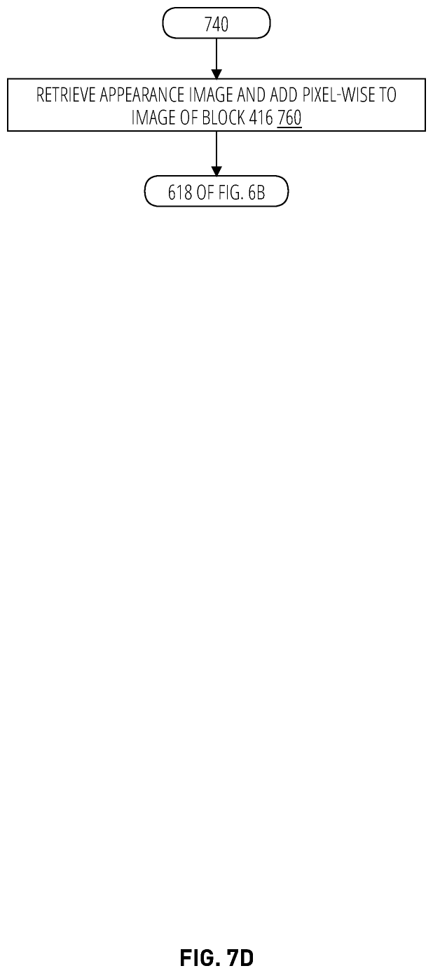

In block 212, the result of the determination of block 210 may be provided via a communication interface, this block being generally optional. The provided result may be displayed on a display device within a graphical user interface. Along with the result of the determination, further data, such as data on the reference coating and adjusted reference coating contained in the associated digital representations may be provided in block 212. Moreover, appearance display data of the reference coating and the adjusted sample coating may be generated as described in relation to FIG. 7A later on and provided in block 212 along the result of the determination, for example if the adjusted sample coating was determined to improve at least one human-perceived attribute. Generation and provision of appearance display data allows to display images of the reference coating and adjusted sample coating within a graphical user interface such that the user can determine whether the adjusted sample coating provides a better color match than the previously selected sample coating.

After the end of block 212, the routine implementing method 200 may end the method or may return to block 202 or may proceed to block 316 of FIG. 3 described in the following.

FIG. 3 illustrates a second non-limiting embodiment of a method 300 for determining at least one adjusted sample coating to match the appearance of a reference coating, said method being implemented by a computing device comprising a computer processor. The computing device may be a stationary or a mobile computing device or may be located in a centralized, decentralized or distributed computing environment described in relation to FIGS. 1A to 1C. The computing device may be a mobile device having an LCD display, such as a tablet or laptop. The computing device may be a stationary device, such as a stationary computer. The reference coating and the sample coating may be effect coatings comprising effect pigment(s). The reference coating and the effect coating may be solid shade coatings comprising color pigments but being free of effect pigments. The sample coating may be prepared as described in the context of FIG. 2. The digital representation of the reference coating may be provided as described in the context of FIG. 2 using one or more sensor(s) 214. The digital representation of the sample coating may be provided by computing resource 216 as described in the context of FIG. 2. The digital representation of the adjusted sample coating may be provided by computing resource 220 as described in the context of FIG. 2. The digital representation of the visual assessment of the sample coating may be provided by display device 218 as described in the context of FIG. 2

Method 300 contains blocks 202 to 210 described in relation to FIG. 2 above.

In addition, method 300 contains further blocks 302 to 312 described in the following. In block 302, the routine implementing method 300 may determine whether the result of the determination performed in block 210 of FIG. 2 is to be provided via a communication interface. The routine implementing method 300 may display a user interface prompting the user to select whether the result is to be displayed or not. Depending on the user selection, the method may proceed to block 304 or 306 described later on. The routine implementing method 300 may determine whether the result is to be provided via a communication interface according to the programming implemented by the routine. For example, the programming may be such that the result is always displayed or that the result is not displayed. In case the routine implementing method 300 may determine that the result of the determination performed in block 210 is to be provided via the communication interface, it may proceed to block 304, otherwise it may proceed to block 306 described later on.

In block 304, the result of the determination performed in block 210 may be provided via a communication interface as described in relation to optional block 212 of FIG. 2. The provided result may be displayed on a display device within a graphical user interface. Along with the result of the determination, further data, such as data on the reference coating and adjusted sample coating contained in the associated digital representations may be provided in block 304.

In block 306, the routine implementing method 300 may determine if at least one human-perceived attribute is improved based on the determination performed in block 210 of FIG. 2.

If at least one human-perceived attribute is improved, method 300 may proceed to block 308. Otherwise, it may proceed to block 310 described later on.

In block 308, the digital representation of the adjusted sample coating (DRAS) may be provided via a communication interface. Providing the DRAS may include providing the adjusted sample coating formulation, such as the exact formulation or a mixing formula which can be used to prepare the adjusted sample coating formulation, to a display device for display within a graphical user interface. Moreover, a display image of the adjusted sample coating and optionally the reference coating and sample coating may be displayed to allow the user to compare the sample coating and adjusted sample coating with the reference coating to determine the degree of matching in terms of appearance. The display images may be generated as described in relation to FIG. 7A. In addition or alternatively, the digital representation may be provided to a data storage medium. After the end of block 308, method 300 may end or may return to block 202 of FIG. 2.

In block 310, at least one further sample coating may be determined. For instance, the further sample coating may correspond to one of the matching sample coating formulations determined by computing resource 216 and not yet having been selected by the user during preparation of the sample coating. Determining matching sample coating formulations not selected by the user may include comparing the data associated with sample coating formulations determined by computing resource 216 with the user input detected upon selecting a sample coating formulation from the determined data associated with the sample coating formulations. In another instance, the further sample coating may be determined based on the digital representation of the reference coating (DRR) provided in block 204 of FIG. 2 by determining best matching colorimetric values, in particular best matching CIEL*a*b* values. Best matching colorimetric values, in particular CIEL*a*b* values, may be determined by determining best matching sample coating(s) and associated matching CIEL*a*b* values, calculating the color differences between the determined CIEL*a*b* values and each matching CIEL*a*b* values to define color difference values and determine if the color difference values are acceptable as previously described. Determining further sample coating(s) may be performed by the processor implementing method 300. Determining further sample coating(s) may be performed by a further processor or computing resource connected to the processor implementing routine 300 via a communication interface.

In block 312, data associated with the further sample coating(s) determined in block 310 may be provided via the communication interface, for example to a display device for display within a graphical user interface. This data may include the formulation(s), mixing formula to prepare the further sample coating(s), names, IDs, barcodes, rankings, ratings of the further sample coatings, etc. Moreover, the data may include display appearance data generated from the appearance data, in particular the CIEL*a*b* values and texture images/texture characteristics, of the further sample coatings as described in relation to FIG. 7A later on. This display appearance data may be used to display realistically looking images of the further sample coating(s) such that the user may be able to select a matching further sample coating by visually comparing the displayed images with the appearance of the reference coating. After the end of block 312, method 300 may end or may return to block 202 of FIG. 2.

FIG. 4 illustrates a flow diagram of an embodiment of generating the digital representation of the sample coating provided in block 202 of FIG. 2. The method illustrated in FIG. 4 may be implemented by computing resource 216 described in the context of FIG. 2. Computing resource 216 may be part of a distributed computing environment, for example as illustrated in FIG. 1C. The digital representation of the sample coating generated according to method 400 of FIG. 4 by computing resource 216 may be provided to the processor implementing method 200 of FIG. 2 or method 300 of FIG. 3 as previously described. Hence, computing resource 216 may be configured to provide input data required during method 200 or method 300.

In block 402, the digital representation of the reference coating (DRR) containing appearance data of the reference coating may be provided. The appearance data, such as reflectance data and/or texture characteristics, may be determined using a multi-angle spectrophotometer as described previously. Providing the digital representation of the reference coating may include retrieving said digital representation based on data being indicative of the reference coating, such as the color name, color number, color code, etc., Said data may be entered by the user via a GUI and may be used by the processor(s) implementing method 400 to retrieve the respective digital representation (DRR) from a database containing the digital representation (DRR) interrelated with the data entered by the user. The digital representation of the reference coating may be provided from one or more sensor(s) 214 as described in the context of FIG. 2. The digital representation of the reference coating (DRR) may be provided based on data contained in the digital representation of the sample coating (DRS) provided to the processor(s) implementing method 400. For instance, a database containing digital representations of reference coatings interrelated with data contained in the digital representation of the sample coating, such as the color name, color code, bar code, etc. of the sample coating, may be accessed to retrieve the corresponding digital representation (DRR) based on the data contained in the provided digital representation of the sample coating from the database.

In block 404, it may be determined whether data of the sample coating, i.e. appearance data and the formulation of the sample coating, is available. This may be determined, for example, by performing a color matching operation described previously to identify best matching sample coatings or by displaying a menu prompting the user to select whether the data is available and detecting the user input. If sample coating data is available, for example by performing a database search for matching sample coatings based on the provided digital representation of the reference coating, selecting one of the identified best matching sample coatings, preparing a sample coating based on the selection and measuring the appearance of the sample coating as described in the context of FIG. 2, 400 may proceed to block 416 described later on. Otherwise, method 400 may proceed to block 406 described in the following and may perform a “match from scratch”-operation.

In block 406, a digital representation of individual color components (DRC) containing optical data, in particular optical constants such as scattering and absorption properties, of individual color components may be provided. The digital representation (DRC) may further contain data being indicative of the individual color components, such as the name, tradename, unique ID or a combination thereof. In one example, the DRC may be provided based on data contained in the digital representation (DRR) provided in block 402. For instance, the DRC may be retrieved or received from a database storing digital representations of individual color components based on the data contained in the DRR provided in block 402.

In block 408, a physical model configured to predict the color of the sample coating by using as input parameters the sample coating formulation and optical data of individual color components may be provided. Suitable physical color prediction models are well known in the state of the art (see for example the physical model disclosed in EP 2149038 B1) and may include physical models describing the interaction of light with scattering or absorbing media, e.g. with colorants in coating layers, such as the Kubelka/Munk model. In this example, the “Kubelka/Munk”-model may be provided in block 408.

In block 410, a “match from scratch” method may be performed and a sample coating formulation may be determined using the digital representation DRR provided in block 402, the digital representation DRC provided in block 406 and the physical model provided in block 408. This method may be applied e.g. if no formulation database is available. In practice the “match from scratch” method may often start with a pre-selection step of components which are expected to be in the reference coating formulation. This pre-selection step is not mandatory. The “match from scratch” method/algorithm may calculate as a first solution one or more preliminary matching sample coating formulations for the reference coating.

In block 412, the calculated matching formula(s) may be provided for display. The formula(s) may be provided to a display device comprising a screen such that the formula(s) can be displayed on the screen of the display device, for example within a GUI. This allows the user to prepare sample coating material(s) based on the displayed formula(s). Preparing the displayed sample coating material(s) may include receiving a user input being indicative of selecting one of the displayed formula and transmitting the selected sample coating formulation(s) to an automatic dosing equipment to automatically prepare respective sample coating material(s) based on the transmitted data. The sample coating material(s) may be prepared by manually dosing the respective components based on the displayed data. The sample coating may be prepared by applying the prepared sample coating formulation to a substrate, such as a metal plate, drying the applied coating layer, applying a commercially available refinish clearcoat composition and curing the applied coating compositions.

In block 414, appearance data of the sample coating prepared from the sample coating formulation(s) provided in block 412 may be provided. Retrieval of appearance data may be performed as described in relation to block 202 of FIG. 2, such as for example by determining the appearance data of the prepared sample coating using one or more sensor(s) 214.

In block 416, the digital representation of the sample coating (DRS) may be generated using the appearance data provided in block 414 and the determined sample coating formulation or using the available sample coating data identified in block 404, i.e. sample coating data obtained by determining the appearance of a sample coating prepared based on an identified matching sample coating. The digital representation of the sample coating (DRS) may contain further data, such as the color name, ID, etc. The generated DRS may be provided in block 202 of FIG. 2.

FIG. 5 illustrates a flow diagram of an embodiment of generating the digital representation of the adjusted sample coating provided in block 206 of FIG. 2. The method illustrated in FIG. 5 may be implemented by computing resource 220 described in the context of FIG. 2. Computing resource 220 may be part of a distributed computing environment, for example as illustrated in FIG. 1C. The digital representation of the adjusted sample coating generated according to method 500 of FIG. 5 by computing resource 220 may be provided to the processor implementing method 200 of FIG. 2 or method 300 of FIG. 3 as previously described. Hence, computing resource 220 may be configured to provide input data required during method 200 or method 300.

In block 502, the digital representation of individual color components (DRC) containing optical data, in particular optical constants such as scattering and absorption properties, of individual color components may be provided as described in relation to block 406 of FIG. 4.

In block 504, a physical model and at least one numerical optimization algorithm may be provided. The physical model may be configured to predict the color of the sample coating by using as input parameters the sample coating formulation and optical data of individual color components. Suitable physical color prediction models are well known in the state of the art (see for example the physical model disclosed in EP 2149038 B1) and may include physical models describing the interaction of light with scattering or absorbing media, e.g. with colorants in coating layers, such as the Kubelka/Munk model. For instance, the “Kubelka/Munk”-model may be provided in block 504. The provided numerical optimization algorithm may be configured to adapt the provided optical data and to adjust the concentration of at least one individual color component present in the provided sample coating formulation by minimizing a given cost function. The provided numerical optimization algorithms may be numerical optimization algorithms configured to adapt the provided optical data by minimizing a given cost function and configured to adapt adjust the concentration of at least one individual color component present in the retrieved sample coating formulation by minimizing a given cost function. The algorithms may be provided from a data storage medium as described previously based on data interrelated with stored algorithms.

In block 506, the color difference between the provided color data of the sample coating and the provided color data of the reference coating may be determined. For instance, the shape similarity of spectral curves may be used to determine the color difference. Use of the shape similarity of the spectral curves is preferable because it avoids changing the characteristic or “fingerprint” of the individual color components which would render the color adjustment process more complicated. In another instance, the color difference may be determined using a color tolerance equation, such as the Delta E (CIE 1994) color tolerance equation, the Delta E (CIE 2000) color tolerance equation, the Delta E (DIN 99) color tolerance equation, the Delta E (CIE 1976) color tolerance equation, the Delta E (CMC) color tolerance equation, the Delta E (Audi95) color tolerance equation or the Delta E (Audi2000) color tolerance equation. These equations may be contained in the digital representation (DRR) or (DRS). In yet another instance, the shape similarity of the spectral curves as well as the color difference determined using a color tolerance equation may be used to determine the color difference. The determined color difference may be interrelated with data being indicative of the sample coating and may be stored on a data storage medium.

In block 508, color data of the sample coating based on the provided formulation of the sample coating, the digital representation DRC provided in block 502 and the physical model provided in block 504 may be determined. The formulation of the sample coating may be contained in the digital representation (DRS) provided in block 202 of FIG. 2. The formulation of the sample coating may be determined in block 412 of FIG. 4. The color data of the sample coating may be determined in block 508 using the provided sample coating formulation and the provided optical data, in particular the optical constants, of the individual color components present within the sample coating formulation as input parameters for the provided physical model.

The predicted color data may be stored on a data storage medium, such an internal data storage medium or a database. The predicted color data may be interrelated with further data, such as data contained in the provided digital representation of the sample coating formulation, to allow retrieval of the data in any one of the following blocks.

In block 510, the color difference between the provided color data of the sample coating and the color data of the sample coating determined in block 508 may be determined. The color difference can be determined as described previously in relation to block 506.

In block 512, an adjusted sample coating formulation may be determined based on
the color differences determined in blocks 506 and 510,
the digital representation of individual color components (DRC) provided in block 502,
the numerical optimization algorithm provided in block 504 and configured to adjust the concentration of at least one individual color component present in the sample coating formulation by minimizing a given cost function starting from the concentrations of the individual color components contained in the retrieved sample coating formulation, and
the physical model provided in block 504.

The numerical method may include the Levenberg-Marquardt algorithm (called LMA or LM), also known as the damped least-squares (DLS) method. The cost function may be a color difference between the color data of the sample coating determined in block 508 and the provided color data of the reference coating. Said color difference can be calculated as described in relation to block 506 above. The given threshold value may be a given color difference.

The formulation of the sample coating may be adjusted in block 512 using the optical constants contained in DRC provided in block 502 and the recursively adjusted sample coating formulation as input parameters for the provided physical model. The provided physical model then determines the color data, such as reflectance data, of the adjusted sample coating formulation based on the input parameters. This determination may be performed for each adjustment of the sample coating formulation until the cost function falls below a given threshold value or the maximum limit of iterations is reached.

In block 514, the digital representation of the adjusted sample coating (DRAS) may be generated using at least the color data determined in block 512. The digital representation of the sample coating (DRAS) may further contain the adjusted sample coating formulation determined in block 512. The generated DRAS may be provided in block 206 of FIG. 2. FIG. 6A illustrates a flow diagram of an example of a method for generating the digital representation of the visual assessment of the sample coating provided in block 208 of FIG. 2. The method illustrated in FIG. 6A may be implemented by display device 218 described in the context of FIG. 2. Display device 218 may be part of a distributed computing environment, for example as illustrated in FIG. 1C. The digital representation of the visual assessment generated according to method 600a of FIG. 6A by display device 218 may be provided to the processor implementing method 200 of FIG. 2 or method 300 of FIG. 3 as previously described. Hence, display device 218 may be configured to provide input data required during method 200 or method 300.

In block 602, a user interface may be displayed on a display device, such as display device 218 described in the context of FIG. 2, which allows the user to select at least one visually perceivable deviation of the sample coating from the reference coating with respect to lightness and/or darkness and/or color and/or texture and/or gloss and/or clearcoat appearance. The user interface may be generated from a user interface presentation and may contain icons, menus, bars, text, labels or a combination thereof. In one example, the user interface further allows the user to select an overall rating for the sample coating. This overall rating may be used by the user to indicate the degree of deviation of the sample coating from the reference coating, for example by selecting a lower overall rating if a large visually perceived deviation is detected while selecting a higher overall rating if a lower visually perceived deviation is detected. The user interface displayed in block 602 may be generated according to the method described in FIG. 6B.

In block 606, a user input being indicative of selecting at least one perceived visual deviation of the sample coating from the reference coating may be detected. For this purpose, the processor implementing method 600a may be coupled via the communication interface with an input device to allow detection of the user input. Suitable input devices include a mouse device, touch-sensitive surface, a keyboard, etc. In this example, the display comprises a touchscreen and thus functions as input device by detecting a touchscreen gesture as user input. The user input may be based on visually perceived differences between the prepared sample coating and the provided reference coating. The user input may be associated with visually perceived differences between the prepared sample coating and the provided reference coating. For instance, the user may visually compare the prepared sample coating with the reference coating and may select the display image of the modified reference coating most closely resembling the appearance of the sample coating or most closely resembling the observed visual difference between the prepared sample coating and the provided reference coating. The visual comparison of the prepared sample coating with the provided reference coating may be performed by the user prior to block 602. The visual comparison of the prepared sample coating with the provided reference coating may be performed by the user during to block 602, for example prior to performing the user input.

In block 604, at least one human-perceived attribute may be assigned to the sample coating in response to the detected user input. For this purpose, the deviation(s) selected in block 606 may be determined. Afterwards, at least one human-perceived attribute may be assigned to the sample coating by mapping the deviation(s) associated with the determined display images to respective human-perceived attribute(s). For this purpose, the deviations associated with the user input detected in block 606 may be determined and may be mapped to the respective human-perceived attribute(s) to allow assigning of the human-perceived attributes to the sample coating. The mapping may be performed using a mapping table in which each deviation, such as, for example, dL+2, is assigned to a respective human-perceived attribute, for example lighter. After the end of block 604, method 600a may return to block 602 or 604, for example if the user wants to select a further visually perceived deviation, or may proceed to block 608 described in the following.

In block 608, the digital representation of the visual assessment of the sample coating (DRVA) may be generated using the human-perceived attributes assigned in block 608. The generated digital representation of the visual assessment of the sample coating may be provided in block 208 of FIG. 2.

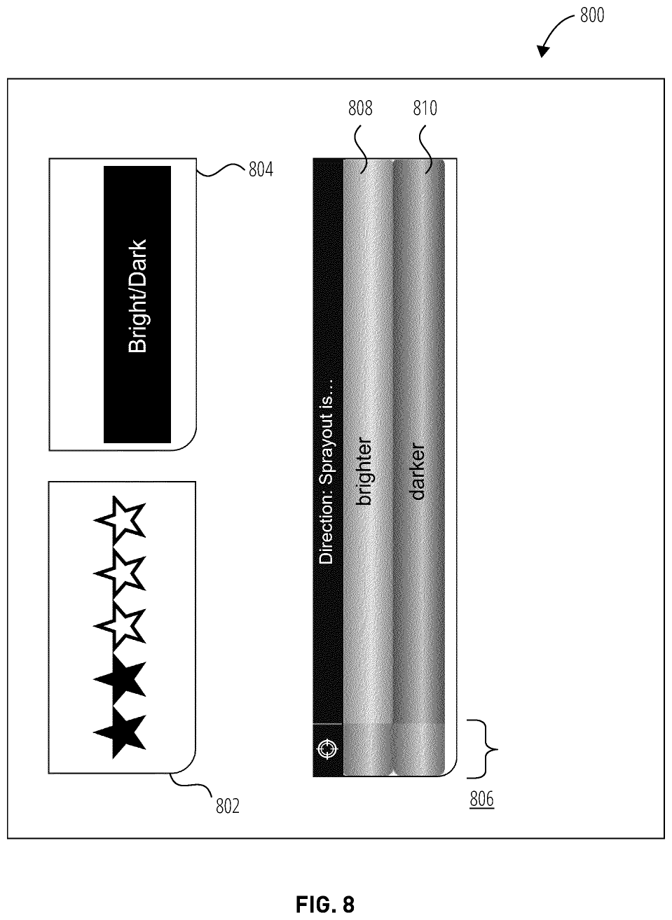

FIG. 6B illustrates a flow diagram of an example of a method for generating the user interface displayed in block 602 of FIG. 6A. The user interface presentation may present modified appearance display data (e.g. display images of a modified reference coating) and optionally appearance display data (e.g. display image(s) of the reference coating). The user interface may contain further content, like icons, text, labels, menus, etc. as described previously. In this example, the user interface further allows the user to select an overall ranking. An example of a user interface presentation generated according to the method described in FIG. 6B is illustrated in FIG. 8.

In block 610, the digital representation of the reference coating (DRR) provided may be provided. The digital representation of the reference coating (DRR) may be provided as described in the context of block 204 of FIG. 2.

In block 612, appearance display data of the reference coating may be generated based on the digital representation of the reference coating (DRR) provided in block 610, this block generally being optional. In general, this block may be performed if the appearance data is not RGB data, such as CIEL*a*b* values, and the display images of the reference coating are to be displayed in block 620. In this example, appearance data in the form of CIEL*a*b* values and texture images are contained in the retrieved DRR and block 612 is performed to allow presentation of display image(s) of the reference coating within the user interface presentation. Presentation of the appearance display data of the reference coating (e.g. display images) next to the modified appearance display data of the modified reference coating allows to mimic the visual comparison of the sample coating and the reference coating in the virtual world such that the user can more easily select the appropriate display image of the modified reference which most closely resembles the visually perceived difference between the sample coating and the reference coating in the physical world. Appearance display data of the reference coating may be generated as described in relation to FIG. 7A below.

In block 614, it may be determined if a user interface is to be generated which comprises at least one category being indicative of a visual deviation of the sample coating from the reference coating. This determination may be made according to the programming of the routine implementing method 600b or may be based on a detected user input indicating the generation of such a user interface. If it is determined in block 614 that such a user interface is to be generated, method 600b may proceeds to block 616. Otherwise, method 600b may proceeds to block 618.

In block 616, a user interface generation may be generated and displayed on the display, the user interface generation comprising at least one category being indicative of a visual deviation of the sample coating from the reference coating. The at least one visual deviation of the sample coating from the reference coating may include a deviation in lightness, a deviation in darkness, a deviation in color, a deviation in texture, a deviation in gloss and a deviation in clearcoat appearance. The category may be denoted with a text label indicating the type of the deviation, such as color deviation, texture deviation, gloss deviation, etc.

In block 618, modified appearance display data of the reference coating based on the DRR provided in block 610 may be generated. The modified appearance display data may be generated by modifying at least part of the appearance data contained in the digital representation of the reference coating provided in block 610 with regard to lightness, darkness, color, texture, gloss, clearcoat appearance or a combination thereof. The method of generating modified appearance display data varies and primarily depends on the type of appearance data contained in the digital representation provided in block 610.

In case said appearance data contains CIEL*a*b* or CIEL*C*h* values, modified appearance display data may be generated by modifying at least part of the CIEL*a*b* or CIEL*C*H* values using predefined color space distance values dL, da and db or dL, dC and dH, respectively. The modified CIEL*a*b* or CIEL*C*h values can be used to generate modified appearance display data as described previously. Apart from the predefined color space distance values, a well-known color tolerance equation, such as the Audi95 tolerance equation or the Audi2000 tolerance equation, can be used during modification of the appearance data. Use of a color tolerance equation may be beneficial because the color space values are weighted according to color and measurement geometry, thus allowing to achieve standardized offsets of the modified appearance display data over the whole color space.

In case the appearance data additionally contains texture images and/or texture characteristics, modified appearance display data may be generated by modifying at least part of the texture image and/or the texture characteristics using texture distance values or by using a synthetic texture image generated from modified texture characteristics.

In case said appearance data contains RGB values, modified appearance display data may be generated by converting the RGB values into CIEL*a*b* values, modifying at least part of the CIEL*a*b* values using predefined color space distance values as described previously and optionally transforming the modified CIEL*a*b* values to modified RGB values to allow display of said data on the display of the computing device.

In this example, modified appearance display data may be generated as described in relation to FIG. 7B by modifying provided CIEL*a*b* values using predefined color space distance values dL, da and db.

In block 622, a user input being indicative of selecting a category may be detected by the display or the computing device comprising the display. The user input may be used to determine which category is selected by the user in block 622. The selected category may be used in block 624 to determine modified appearance display data for this category. For example, if the user selects the category “color”, the appearance data may only be modified in block 624 with respect to the color to obtain display images of the modified reference coating showing a color shift, such as greener, redder, bluer, yellower, lighter, darker, more chromatic, less chromatic, with respect to the display images of the reference coating.

In block 624, modified appearance display data of the reference coating may be generated based on the appearance data contained in the digital representation of the reference coating provided in block 610 and the user input detected in block 622. For this purpose, the category selected by the user in block 622 may be determined and the appearance data contained in the digital representation of the reference coating provided in block 610 may be modified with respect to the determined category. For example, if the user selects category “color”, the appearance data may be modified with respect to color, such that the color may appear greener or redder or bluer or yellower or more chromatic or less chromatic or lighter or darker. This may include modifying the CIEL*a*b* or CIEL*C*h* values as described in relation to FIG. 7B or the RGB values as described previously. If the user selects category “texture”, a texture layer may be added as described in relation to FIG. 7B below to modify the texture such that it appears coarser or finer or more sparkly or less sparkly.

In block 620, a user interface presentation may be generated that presents the modified appearance display data generated in block 618 or 624 and optionally the display appearance data generated in block 612. The generated user interface presentation may then be displayed on the display of the computing device. In this example, the user interface presentation may comprise an image of the reference coating (i.e. display appearance data of the reference coating generated in block 612) adjacent to at least one display image of the modified reference coating (i.e. modified display appearance data generated in block 618 or 624), for example as shown in FIG. 8. The user interface presentation may comprise further icons, text, labels buttons, menus and links to improve user guidance. After then end of block 620, method 600b may proceed to block 604 of FIG. 6A described previously.

FIG. 7A illustrates a flow diagram of an example of a method for generating appearance display data of the reference coating and/or the sample coating and/or the adjusted sample coating and/or further sample coating(s). For instance, the method may be performed in block 212 of FIG. 2, block 312 of FIG. 3 and/or block 612, 618 or 622 of FIG. 6A. The appearance data used in method 700a may contain CIEL*a*b* values as well as associated measurement geometries, i.e. the measurement geometries associated with the reflectance data which is used to determine said CIEL*a*b* values. The reflectance data of the respective coating may have been determined at a plurality of measurement geometries including at least one gloss and one non-gloss measurement geometry because the reference coating is an effect coating. The reflectance data of the respective coating may have been determined at a single measurement geometry, for example if the reference coating is a solid color coating not containing effect pigments.

In block 702, an ordered list of measurement geometries may be generated from the measurement geometries contained in the appearance data of the respective coating, e.g. sample coating and/or reference coating and/or adjusted sample coating. The ordered list of measurement geometries may be generated by selecting at least one pre-defined measurement geometry from the geometries contained respective appearance data, optionally sorting the selected measurement geometries according to at least one pre-defined sorting criterium if more than one measurement geometry is selected, and optionally calculating the accumulated delta aspecular angle for each selected measurement geometry if more than one measurement geometry is selected.

The pre-defined measurement geometry may be an intermediate measurement geometry, such as 45°. In this case, only one measurement geometry may be selected, and no sorting is required. Selection of an intermediate measurement geometry allows to generate appearance display data under diffuse illumination conditions (e.g. cloudy weather conditions). The predefined measurement geometries may include at least one gloss geometry, such as 15 and 25° and at least one non-gloss measurement geometry, such as 45° and/or 75° and/or 110°. The selected pre-defined measurement geometries may be sorted according to a pre-defined sorting criterium, such as a defined order of measurement geometries. In this example, a defined order of 45°>25°>15°>25°>45°>75 is used. In another example, a defined order of −15°>15°>25°>45°>75°>110° is used. The pre-defined measurement geometry/geometries and/or the pre-defined sorting criterium may be retrieved from a database based on the appearance data of the respective coating or further data, such as the user profile, prior to generating the ordered list.

In case more than one digital representation is used to generate the ordered list of measurement geometries in block 702, it may be preferred if the same list of ordered measurement geometries is generated for all appearance data to be displayed to allow generation of display images which can be compared to each other.

After sorting the selected pre-defined measurement geometries according to the pre-defined sorting criterium, the delta aspecular angle may be calculated for each selected measurement geometry as described previously (see for example the previously listed table).

In block 704, empty images with defined resolutions may be generated for each appearance data set to be generated later on. The resolution may vary greatly and generally depends on the resolution of the color and texture data contained in the retrieved digital representations. It should be mentioned that the order of blocks 702 and 704 may also be reversed, i.e. block 704 may be performed prior to block 702.

In block 706, it may be determined whether at least one L* value included in the CIEL*a*b* values of the appearance data of the respective coating is larger than 95. If it is determined in block 706 that at least one L*value of all L*values is higher than 95, method 700a may proceed to block 708. If all provided L* values are below 95, method 700a may proceed to block 710.

In block 708, all retrieved L* values may be scaled using a lightness scaling factor si to generate a scaled digital representation (also denoted as SDR) or scaled appearance data. In this example, the lightness scaling factor of formula (1) may be used

$${s}_{L} = \frac{x}{{L}_{max}} \qquad ( 1 )$$

in which
x=95, and
Lₘₐₓ is the maximum L* value of the CIEL*a*b* values included in the appearance data retrieved in block(s) 202 &/or 204 &/or 206 &/or 320.

In case appearance display data of different coatings, such as the reference coating and the sample coating or the reference coating, the adjusted sample coating and the sample coating, or the reference coating and further sample coating(s), is to be displayed within the same user interface, all L′values contained in the appearance data associated with the coatings to be displayed adjacent to each other to allow comparison are scaled as previously described if at least one L*value of said appearance data is higher than 95. For example, if display images of the reference coating, sample coating and adjusted sample coating are to be displayed adjacent to each other and at least one L′value in the retrieved color data associated with said coatings is higher than 95, all L*values associated with said coatings are scaled using the scaling factor as described previously. Use of this lightness scaling factor allows to retain the color information contained in the gloss measurement geometries by compressing the color space while the existing color distances are kept constant.

In block 710, color images of the reference coating or the sample coating or the adjusted sample coating or the further sample coating(s) may be generated by calculating the corresponding CIEL*a*b values for each pixel of each image generated in block 704 based on
the ordered list of measurement geometries generated in block 702 and
the CIEL*a*b* values contained in the appearance data of the respective coating or the scaled digital representation generated in block 708.

In this example, the calculated CIEL*a*b* values may be converted to sRGB values and may be stored in an internal memory of the processing device performing this block. In this example, the corresponding CIEL*a*b* values for each pixel of the generated image may be calculated by correlating one axis of each image generated in block 704 with the ordered list of measurement geometries generated in block 702 and mapping the generated ordered list of measurement geometries and associated CIEL*a*b* values or scaled CIEL*a*b* values of the reference coating to the correlated row in the respective created image. For example, the color image for the reference coating may be obtained by correlating the y-axis of the image generated in block 704 with the list of measurement geometries generated in block 702 and mapping the generated ordered list of measurement geometries and associated CIEL*a*b* values of the reference coating or scaled CIEL*a*b* values obtained in block 708 to the correlated row in the generated image.

In block 712, it may be determined whether a texture layer is to be added to the color image generated in block 710. This determination may be made based on the appearance data of the respective coating. For example, if the appearance data contains texture image(s) and/or texture parameters, it may be determined that a texture layer is to be added and method 700a may proceed to block 714. Otherwise, method 700a may proceed to block 212 of FIG. 2 or block 312 of FIG. 3 or block 612 of FIG. 6B.

In block 714, it may be determined whether the texture image may be generated from contained in the appearance data of the respective coating. If the texture image is to be generated using respective appearance data, method 700a may proceed to block 718. Otherwise, method 700a may proceed to block 716, for example if the respective appearance data does not include acquired texture images or texture images cannot be retrieved from a database based on the respective appearance data.

In block 716, synthetic texture image(s) may be generated by
creating an empty image having the same resolution as the image generated in block 704,
obtaining a target texture contrast cᵥ,
generating a random number by a uniform or a gaussian random number generator between −cᵥ and +cᵥ for each pixel in the created image and adding the generated random number to each pixel in the created image, and
blurring the resulting image using a blur filter, in particular a gaussian blur filter.

The target texture contrast cy may be provided by retrieving the coarseness and/or sparkle characteristics from respective appearance data and providing the retrieved coarseness and/or sparkle characteristics, in particular coarseness characteristics, as target texture contrast cᵥ. If said data does not contain texture characteristics, the target texture contrast cᵥ can be obtained by retrieving the target texture contrast cy from a database based on the data appearance data. The target texture contrasts cy stored in the database can be obtained, for example, by associating a defined texture target contrast cᵥ with an amount or a range of amounts of aluminum pigment present in the coating formulation used to prepare the respective coating and retrieving the respective texture target contrast cᵥ based on the formulation data associated with the respective coating.

In block 718, a texture image may be generated from the respective acquired texture image(s), in particular the texture image acquired at a measurement geometry of 15°, by retrieving said texture images from the respective appearance data or by retrieving the respective acquired texture image, in particular the texture image acquired at a measurement geometry of 15°, from a data storage medium based on the respective appearance data.

In block 720, modified texture images for each acquired or synthetic texture image provided in block 716 or 718 may be generated by computing the average color of each acquired or synthetic texture image provided in block 716 or 718 and subtracting the computed average color from the respective provided acquired or synthetic texture image. The average color of each provided acquired or synthetic texture image can be computed as previously described by adding up all pixel colors of the provided acquired or synthetic texture image and dividing this sum by the number of pixels of the provided acquired or synthetic texture image or by computing the pixel-wise local average color.

In block 722, appearance display data of the reference coating and/or the sample coating and/or the adjusted sample coating and/or the further sample coating(s) may be generated by adding the respective modified texture image generated in block 720 pixel-wise weighted with a lightness scaling factor S_{L} and an aspecular-dependent scaling function sf_{aspecular} to the respective color image generated in block 710. The aspecular dependent scaling function may weight each pixel of the texture layer in correlation with the aspecular angles corresponding to the measurement geometries present in generated ordered list of measurement geometries. This allows to weight the pixels of the texture layer in correlation with the visual impression of the effect coating layer when viewed by an observer under different measurement geometries and therefore results in generated appearance data closely resembling the visual impression of the effect coating when viewed under real-world conditions.

In this example, one of the following aspecular dependent scaling functions (2a) and (2b) may be used

$$s {f}_{a s p e cular} = \frac{( {aspecular}_{max} - aspecular )}{{aspecular}_{max}} \qquad ( 2 a )$$

$$s {f}_{a s pecular} = {( \frac{( {aspecular}_{max} - aspecular )}{{aspecular}_{max}} )}^{2} \qquad ( 2 b )$$

in which

aspecularₘₐₓ is the measurement geometry in the ordered list corresponding to the highest aspecular angle, and

aspecular is the respective measurement geometry of a pixel of the texture layer or

the value of the aspecular-dependent scaling function sf_{aspecular} is set to 1 if the ordered list generated in block 702 includes only one measurement geometry or does not include any gloss and flop measurement geometries.

The lightness scaling factor S_{L} used in block 722 may correspond to the lightness scaling factor S_{L} used in block 708, i.e. the same lightness scaling factor S_{L} is preferably used in blocks 708 and 722, or is 1 in case no lightness scaling factor S_{L} used (i.e. block 708 is not performed). Use of the same lightness scaling factor S_{L} in block 722 allows to adjust the lightness of the texture image to the lightness of the color image, thus preventing a mismatch of the color and texture information with respect to lightness.

The addition may be performed according to formula (3)

$$AI ( X , Y ) = CI ( X , Y ) + {s}_{L} * {s}_{c} * s {f}_{a s p e cular} * modified TI ( X , Y ) \qquad ( 3 )$$

in which

AI (X, Y) is the image resulting from addition of the texture layer to the respective generated color image,

CI (X,Y) is the generated color image,

s_{L} corresponds to the lightness scaling factor used to generate the respective color image or is 1 in case no lightness scaling factor is used to generate the respective color image,

S_{c} is the contrast scaling factor and is set to 1,

sf_{aspecular} is the aspecular-dependent scaling function, and modified TI (X, Y) is the modified texture image.

The generated display appearance data may be used to display images of the reference coating, sample coating, adjusted sample coating and futher coatings in any one of the methods described in the context of FIGS. 2, 3 and 6A.

FIGS. 7B to 7D show an illustrative method 700b for generating modified appearance display data as described in relation to block 618 or 624 of FIG. 6B. In this example, the appearance data to be modified (i.e. the appearance data of the reference coating) may contain CIEL*a*b* values determined at a plurality of measurement geometries as well as associated measurement geometries, i.e. the measurement geometries associated with the reflectance data which is used to determine said CIEL*a*b* values.

In block 724, it may be determined whether a user input has been detected, i.e. whether the user has selected a category as described in relation to blocks 614 and 622 of FIG. 6B. If a user input has been detected, method 700b may proceed to block 726, otherwise it may proceed to block 728 described later on.

In block 726, modified appearance data may be generated based on the appearance data contained in the provided digital representation of the reference coating and the user input detected in block 622 of FIG. 6B. Modified appearance data may be generated by modifying the retrieved appearance data using predefined color space distance values dL, da and db and/or texture distance values as described in relation to block 616 of FIG. 6B depending on the category selected by the user in block 622 of FIG. 6B. Modified appearance data may be generated by modifying the retrieved appearance data using predefined color space distance values dL, da and db, a well-known color tolerance equation, such as the Audi95 or Audi2000 color tolerance equation, and/or texture distance values as described in relation to block 616 of FIG. 6B depending on the category selected by the user in block 622 of FIG. 6B. Use of the Audi95 or Audi2000 color tolerance equation may be beneficial because the color space values are weighted according to color and measurement geometry, thus allowing to achieve standardized offsets of the modified appearance data from the appearance data of the reference coating over the whole color space.

In block 728, modified appearance data may be generated based on the appearance data contained in the digital representation of the reference coating. The modified appearance data may be generated as described in relation to block 726 without considering the user input. In one example, all appearance data of the adjusted sample coating is modified. In another example, only part of the retrieved appearance data is modified based on predefined rules, for example based on appearance data of the reference coating.

In block 730, an ordered list of measurement geometries may be generated. Generation of the ordered list of measurement geometries may be performed as described in relation to block 702 of FIG. 7A. The same ordered list of measurement geometries may be generated as in block 702 of FIG. 7A to allow comparison of the appearance display data associated with the reference coating with the modified appearance display data because each line in the displayed data (e.g. the display images of modified reference and the reference coatings) belongs to the same measurement geometry (e.g. the same aspecular angle) if the generated appearance data is presented side by side in a horizontal arrangement in the user interface presentation.

In block 732, image(s) with defined resolutions may be generated. In The same resolution as in block 704 of FIG. 7A may be used to obtain display images having the same size as the display images of the reference coating. Use of the same resolution allows to easily compare the display image(s) of the reference coating with the display image(s) of the modified reference coating. In another example, a different resolution is used to obtain larger or smaller display images than the display images of the reference coating.

In block 734, it may be determined whether at least one L′value included in the modified CIEL*a*b* values generated in block 726 or 728 or—if appearance display data of the reference coating is to be displayed adjacent to the modified appearance display data-if at least one L*value included in the digital representation of the reference coating—is larger than 95. If it is determined in block 734 that at least one L*value of all modified L*values generated in block 726 or 728 or optionally at least one L*value of the reference coating is higher than 95, method 700b may proceed to block 736. If all modified L* values and optionally all L*values of the reference coating are below 95, method 700b may proceed to block 738 described later on.

In block 736, all modified L* values may be scaled using a lightness scaling factor S_{L} to obtain scaled modified appearance data (denoted as SMAP). The lightness scaling factor of formula (1) as described in relation to block 708 of FIG. 7A may be used. With preference, the same scaling factor S_{L} may be used as in block 708 of FIG. 7A to avoid differences in lightness due to the use of different lightness scaling factors.

In block 738, color image(s) of the modified reference coating may be generated as described in relation to block 710 of FIG. 7A by calculating the corresponding CIEL*a*b values for each pixel of each image generated in block 732 based on
the ordered list of measurement geometries generated in block 730 and
the modified CIEL*a*b* values generated in block 726 or block 728 or the scaled modified appearance data generated in block 736.

In block 740, it may be determined whether a texture and/or clearcoat appearance layer is to be added to the color image generated in block 738. This determination may be made based on the provided appearance data or the modified appearance data. For example, if the provided or modified appearance data contains texture image(s) and/or texture parameters, it may be determined that a texture layer is to be added and method 700b may proceed to block 742. In case no texture and clearcoat appearance layer is to be added, method 700b may proceed to block 618 or 624 of FIG. 6B. This may be, for example, the case if the reference coating is a solid or straight shade coating not comprising any effect pigments and thus not having any visual texture. In case only a clearcoat appearance layer is to be added, for example if the clearcoat appearance of a solid shade coating is to be modified, method 700b may proceed to block 760 described later on.

In block 742, it may be determined whether a texture image is to be generated from the appearance data of the reference coating or the modified data (i.e. the modified appearance data generated in block 726 or 728). If the texture image is to be generated using retrieved or modified data, method 700b may proceed to block 744. Otherwise, method 700b may proceed to block 746, for example if the retrieved or modified data does not include acquired texture images or texture images cannot be retrieved from a database based on the retrieved or modified data.

In block 744, texture image may be generated from the respective texture image(s), in particular the texture image acquired at a measurement geometry of 15°, by retrieving said texture images from the provided or modified data or by retrieving the respective texture image, in particular the texture image acquired at a measurement geometry of 15°, from a data storage medium based on the provided or modified data.

In block 746, synthetic texture image(s) may be generated as described in relation to block 716 of FIG. 7A.

In block 748, modified texture images may be generated for each texture image generated in block 744 or 746 by computing the average color of each texture image provided in block 744 or 746 and subtracting the computed average color from the respective provided acquired or synthetic texture image as described in relation to block 720 of FIG. 7A.

In block 750, it may be determined whether the texture contrast is to be scaled, for example by using a texture scaling factor during generation of the modified appearance display data. This determination may be made according to the programming and may be based on the type of effect pigments present in the reference coating formulation, the modifications to be displayed with respect to the texture, etc., In case it is determined that the texture contrast is to be scaled, method 700b may proceed to block 752. Otherwise, method 700b may proceed to block 754 described later on.

In block 752, the respective modified texture image generated in block 748 may be added pixel-wise weighted with a lightness scaling factor S_{L}. an aspecular-dependent scaling function Sf_{aspecular} and a texture contrast scaling factor s_{c} to the respective color image generated in block 738 as described in relation to block 722 of FIG. 7A with the exception, that the texture contrast scaling factor s_{c} is set to values of more or less than 1. With preference, the same lightness scaling factor S_{L} as used in block 708 of FIG. 7A and block 736 may be used. Moreover, the same aspecular-dependent scaling function sf_{aspecular} as used in block 722 of FIG. 7A may be used in block 752. The use of the texture contrast scaling factor s_{c} allows to scale the contrast of the texture to visualize color differences by setting the value of the texture contrast scaling factor to values of more than 1 (to obtain a higher texture contrast) or to lower than 1 (to obtain a lower texture contrast).

In block 754, the respective modified texture image generated in block 748 may be added pixel-wise weighted with a lightness scaling factor S_{L} and an aspecular-dependent scaling function Sf_{aspecular} to the respective color image generated in block 738 as described in relation to block 722 of FIG. 7A.

In block 756, it is determined whether a clearcoat appearance layer is to be added to the image generated in block 752 or 754. This determination may be made according to the user input detected in block 620 of FIG. 6B or according to the programming and may be based, for example, on modifications to be displayed with respect to the clearcoat appearance. If it is determined in block 756 that an appearance layer is to be added, method 700b may proceed to block 758. Otherwise, method 700b may proceed to block 618 or 624 of FIG. 6B.

In block 758, the modified appearance display data may be generated by retrieving a clearcoat appearance image or layer, for example from a database, and adding the retrieved image or layer pixel-wise to the image obtained in block 752 or 754. Afterwards, method 700b may proceed to block 618 or 624 of FIG. 6B.

In block 760, modified appearance display data may be generated by retrieving a clearcoat appearance image or layer, for example from a database, and adding the retrieved image or layer pixel-wise to the color image generated in block 738. Afterwards, method 700b may proceed to block 618 or 624 of FIG. 6B.

FIG. 8 shows an illustrative user interface presentation 800 displayed on the display of a computing device which can be used generate the digital representation of the visual assessment of the sample coating as described in relation to FIG. 6A. The display device may be display device 218 described in the context of FIG. 2. The user interface presentation may be generated according to the method described in FIGS. 6B to 7D, for example with display device 218 as described in FIG. 2. In this non-limiting case, the presentation 800 indicates the category 804 of the modification of the reference coating. In this example, the brightness and darkness of the reference coating was modified. The category may be selected by the user as described in relation to FIG. 6B above. The user interface presentation 800 further displays an overall rating 802 of the sample effect coating. The overall rating can be defined by the user by selecting the appropriate number of stars, for example by clicking on each star, and may be used to determine the term being indicative of the significance used to determine whether the adjusted sample coating improves at least one human-perceived attribute as described previously.

The user interface presentation 800 further comprises a set of display images of reference coating 806 and associated modified reference coatings 808 and 810. Adjacent to each reference coating 806, display images of modified reference coatings 808 and 810 are displayed which have been generated by modifying the reference coating with respect to the brightness and darkness, respectively. In this example, the display images of the reference coating were generated according to the method described in relation to FIG. 7A and the display images of the modified reference coating were generated according to the method described in relation to FIG. 7B (without addition of a texture layer and an appearance layer). A label is displayed on each display image of the modified reference coating to indicate the modification performed with respect to the reference coating. This allows to increase user comfort during selection of the display image of the modified reference coating, which most closely resembles the visually perceived deviation of the sample coating from the reference coating.

The user interface presentation 800 may further include a comment field and/or further buttons, icons, menus (not shown).

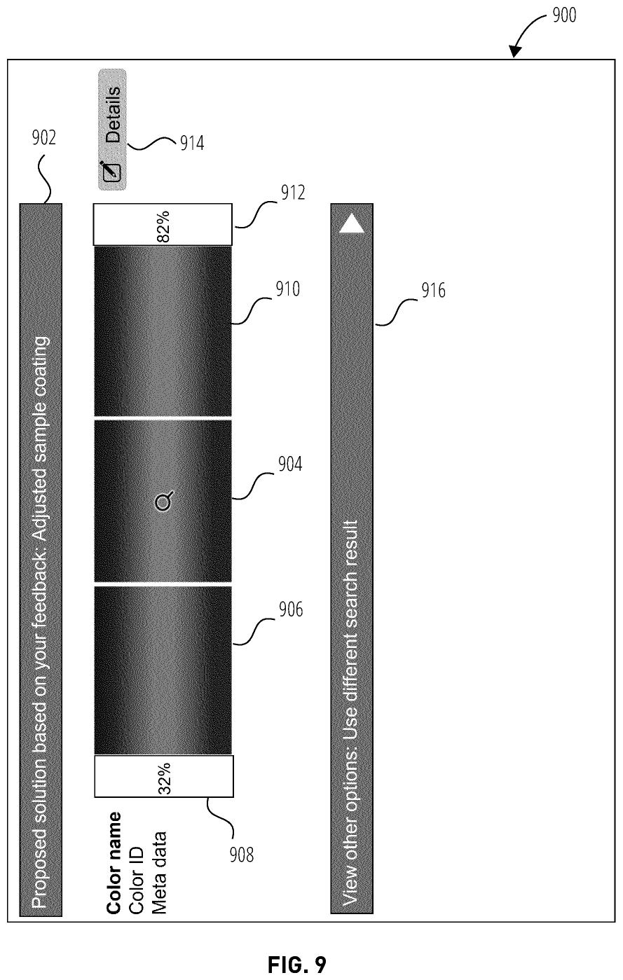

FIG. 9 shows an illustrative user interface presentation 900 displayed on the display of a computing device, such as a computing device of any one of FIGS. 1A to 1C, which comprises appearance display data of a reference coating 904, appearance display data of a sample coating 906 and appearance display data of an adjusted sample coating 910 determined to improve at least one human-perceived attribute. The user interface presentation 900 of FIG. 9 may be displayed, for example, in block 308 of FIG. 3, i.e. in case it was determined in block 306 that the adjusted sample coating improves at least one human-perceived attribute (which can be assigned to the sample coating using the method described in FIGS. 6A and 6B).

The user interface presentation contains a header 902 informing the user that the display images shown on the user interface presentation 900 refer to the adjusted sample coating. Next to the display image of the sample coating 906 selected by the user during the first color matching operation, a matching score 908 is shown which indicates the degree of matching between the sample coating and the reference coating. A matching score 912 is also shown next to the display image of the adjusted sample coating. The user interface presentation moreover contains information on the reference coating, such as the color name, color ID and further meta data, for example the car manufacturer, mixing formula, etc., Details of the adjusted sample coating, for example the remission spectra, may be displayed upon selecting the button “Details” 914.

Below the display images, a further header 916 is displayed which allows the user to view further sample coatings, for example sample coatings which have been identified as suitable matches in a previous color matching operation performed to select the sample coating.

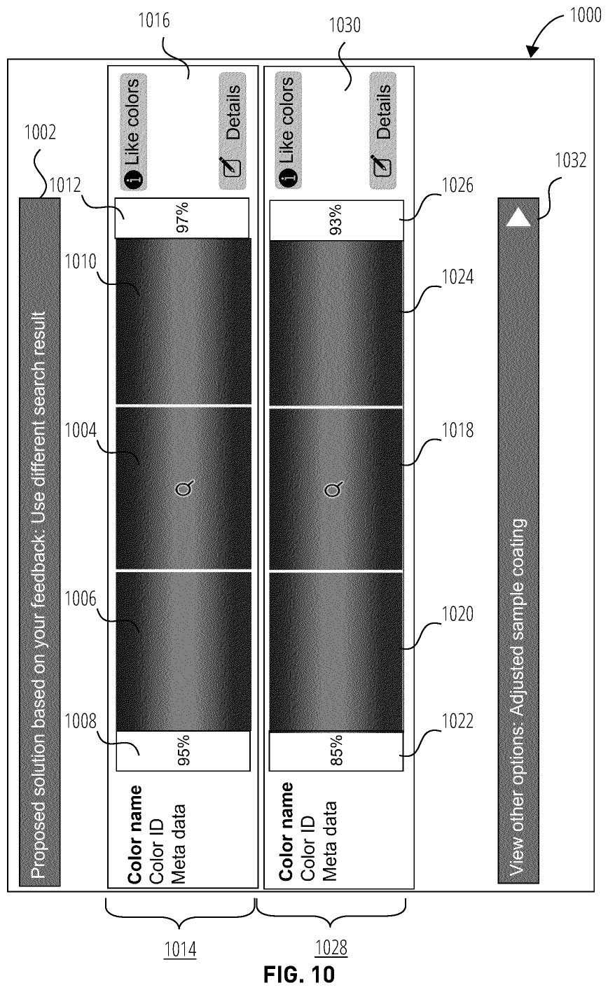

FIG. 10 shows an illustrative user interface presentation 1000 displayed on the display of a computing device, such as a computing device of any one of FIGS. 1A to 1C, which comprises appearance display data of a reference coating 1004, 1018 and appearance display data of further sample coatings 1006, 1010, 1020, 1024. The user interface presentation 1000 of FIG. 10 may be displayed, for example, in block 322 of FIG. 3, i.e. in case it was determined in block 310 that the adjusted sample coating does not improve at least one human-perceived attribute (which can be assigned to the sample coating using the method described in FIGS. 6A and 6B).

The user interface presentation contains a header 1002 informing the user that the display images shown on the user interface presentation 1000 refer to matching sample coatings identified upon performing a database search. In this example, the user interface presentation 1000 comprises 2 database search results 1014, 1028. In another example, more or less database search results are displayed on the user interface presentation 1000. Each database result is displayed using display images (i.e. display appearance data) of the reference coating 1004, 1018, the identified matching sample coating 1006, 1020 and an automatically adjusted sample coating 1010, 1026 which is, however, not corresponding to the adjusted sample coating because the adjusted sample coating was determined using the appearance data of a sample coating produced by the user whereas the automatically adjusted sample coating is obtained by adjusting the database result(s) associated with appearance data generated using highly defined application parameters. Since the application parameters of the user normally deviate from the highly defined application parameters and said parameters have a significant influence on the resulting appearance, the adjusted sample coating is generally a better color match than the automatically adjusted sample coating. The automatically adjusted sample coating can, for example, be generated from appearance data associated with the identified database search results (i.e. sample coatings) using the method described in relation to FIG. 5. Next to each sample coating and automatically adjusted sample coating, the matching score 1008, 1022, 1012, 1026 is displayed to indicate to the user the determined degree of matching. The automatic adjustment of the identified sample coating is performed to improve the degree of matching as illustrated by increased matching scores 1012, 1026 as compared to matching scores for the identified further sample coatings 1008, 1022.

Fields 1016 and 1030 provide buttons to view details on the sample coating as well as to display relations of the database search result to similar color shades.

Below the display images, a further header 1032 is displayed which allows the user to view the adjusted sample coating which was determined not to improve at least one human-perceived attribute.

The present disclosure has been described in conjunction with a preferred embodiment as examples as well. However, other variations can be understood and effected by those persons skilled in the art and practicing the claimed invention, from the studies of the drawings, this disclosure and the claims. Notably, it is not required that the different steps are performed at a certain place or at one node of a distributed system, i.e. each of the steps may be performed at a different nodes using different equipment/data processing units.

In the claims as well as in the description the word “comprising” or “including” does not exclude other elements or steps and the indefinite article “a” or “an” does not exclude a plurality. A single element or other unit may fulfill the functions of several entities or items recited in the claims. The mere fact that certain measures are recited in the mutual different dependent claims does not indicate that a combination of these measures cannot be used in an advantageous implementation.

1. A computer-implemented method for determining at least one adjusted sample coating to match the appearance of a reference coating said method comprising:
(i) providing to a computer processor via a communication interface
a digital representation of the sample coating containing appearance data of the sample coating and the sample coating formulation(s),
a digital representation of the reference coating containing appearance data of the reference coating,
a digital representation of an adjusted sample coating containing appearance data of the adjusted sample coating and optionally the adjusted sample coating formulation(s), and
a digital representation of a visual assessment of the sample coating containing at least one human-perceived attribute assigned to the sample coating by a human observer,
(ii) determining with the computer processor if the adjusted sample coating improves at least one human-perceived attribute assigned to the sample coating based on the digital representations provided in step (i); and
(iii) optionally providing the result of the determination of step (ii) via a communication interface.

2. The method according to claim 1, wherein the appearance data includes reflectance data, color space data, shortwave values, longwave values, DOI values, texture parameters.

3. The method according to claim, wherein providing the digital representation of the adjusted sample coating includes
calculating with a further computer processor an adjusted sample coating formulation based on the digital representation of the reference coating and the sample coating,
calculating appearance data based on the calculated adjusted sample coating formulation, and
providing the calculated color data and optionally the adjusted sample coating formulation as digital representation of the adjusted sample coating via the communication interface.

4. The method according to claim 1, wherein the human-perceived attribute is a deviation of the sample coating from the reference coating with respect to lightness and/or darkness and/or color and/or texture and/or gloss and/or clearcoat appearance.

5. The method according to claim 1, wherein providing the digital representation of the visual assessment of the sample coating includes
providing a user interface on the screen of a display device allowing the user to select at least one perceived deviation of the sample coating from the reference coating with respect to lightness and/or darkness and/or color and/or texture and/or gloss and/or clearcoat appearance,
detecting a user input being indicative of selecting at least one perceived deviation of the sample coating from the reference coating,
generating the digital representation of the visual assessment of the sample coating by assigning at least one human-perceived attribute to the sample coating based on the detected user input, and
providing the generated digital representation of the visual assessment via the communication interface.

6. The method according to claim 5, wherein the user interface further allows the user to select an overall rating for the sample coating layer.

7. The method according to claim 6, wherein assigning at least one human-perceived attribute to the sample coating based on the detected user input includes mapping the deviation(s) associated with the detected user input to respective human-perceived attribute(s).

8. The method according to claim 1, wherein step (ii) includes
(ii-1) determining appearance data difference(s) based on the provided digital representations of the sample coating and the reference coating,
(ii-2) determining whether at least one human-perceived attribute can be mapped to the determined appearance data difference(s), and
(ii-3) in accordance with the determination that at least one human-perceived attribute can be mapped to the determined appearance difference(s), determining if the adjusted sample coating improves at least one human-perceived attribute assigned to the sample coating or in accordance with the determination that at least one human-perceived attribute cannot be mapped to the determined color difference(s), proceeding to optional step (iii) and/or further steps.

9. The method according to claim 1, wherein determining if the adjusted sample coating improves at least one human-perceived attribute assigned to the sample coating includes
determining the human-perceived attributes assigned to the sample coating based on the provided digital representation of the visual assessment of the sample coating,
determining for each determined human-perceived attribute the difference between the adjusted sample coating and the reference as well as the difference between the sample coating and the reference coating based on the provided digital representations of the adjusted sample coating, the sample coating and the reference coating, and
determining for each determined human-perceived attribute if the difference between the adjusted sample coating and the reference coating is less than the difference between the sample coating and the reference coating.

10. The method according to claim 9, wherein determining the difference between the adjusted sample coating and the reference as well as the difference between the sample coating and the reference coating for each determined human-perceived attribute includes calculating the average attribute of each measurement geometry and determining the absolute value for each calculated average.

11. The method according to claim 9, wherein the determining the difference between the sample coating and the reference coating for each determined human-perceived attribute includes subtracting a term being indicative of the significance from the difference between the sample coating and the reference coating.

12. The method according to claim 1, further comprising a step (iv) of
providing the digital representation of the adjusted sample coating via the communication interface in accordance with the determination that the adjusted sample coating improves at least one human-perceived attribute assigned to the sample coating, or
determining at least one further sample coating based on the provided digital representation of the reference coating and providing the determined further sample coating(s) via the communication interface in accordance with the determination that the adjusted sample coating does not improve at least one human-perceived attribute assigned to the sample coating.

13. An apparatus for determining at least one adjusted sample coating to match the appearance of a reference coating, the apparatus comprising: one or more computing nodes; and one or more computer-readable media having thereon computer-executable instructions that are structured such that, when executed by the one or more computing nodes, cause the apparatus to perform the method according to claim 1.

14. A computer program element with instructions,
which, when executed by a computing device, is configured to carry out the steps of the method according to claim 1.

15. A client device for generating a request to determine at least one adjusted sample coating to match the appearance of a reference coating, wherein the client device is configured to provide a digital representation of a sample coating, a digital representation of a reference coating and a digital representation of a visual assessment of the sample coating to a server device.

16. The method according to claim 1, wherein the method for determining at least one adjusted sample coating to match the appearance of a reference coating is performed during vehicle repair.

17. The method according to claim 1, wherein the method is for determining at least one adjusted sample coating to match the appearance of a reference coating during vehicle repair.

18. The method according to claim 2, wherein the color space data comprises CIEL*a*b* values or CIEL*C*h* values.

19. The method according to claim 2, wherein texture parameters corresponds to sparkle characteristics and/or coarseness characteristics, texture images or a combination thereof.

20. A computer program element with instructions, which, when executed by a computing device, is configured to carry out the steps of the method as provided by the apparatus of claim 13.
